(19) United States
(12) Patent Application Publication
(10) Pub. No.: US 2026/0145068 A1
(43) Pub. Date: May 28, 2026

(54) VIRTUAL ELEMENT DECORATION

(71) Applicant: TENCENT TECHNOLOGY (SHENZHEN) COMPANY LIMITED, Shenzhen (CN)

(72) Inventor: Ziqi WEI, Shenzhen (CN)

(73) Assignee: TENCENT TECHNOLOGY (SHENZHEN) COMPANY LIMITED, Shenzhen (CN)

(21) Appl. No.: 19/451,852

(22) Filed: Jan. 16, 2026

Related U.S. Application Data
(63) Continuation of application No. PCT/CN2024/120605, filed on Sep. 24, 2024.

(30) Foreign Application Priority Data
Dec. 21, 2023 (CN) 202311790767.4

(51) Int. Cl. A63F 13/52

(52) U.S. Cl. CPC A63F 13/52

(57) ABSTRACT

In a virtual element decoration method, a first virtual object and an element decoration area are output for display in a virtual scene. The element decoration area includes a region with an element decoration function. The element decoration function is configured to provide a decoration for the first virtual object. An object control operation performed on an object control element associated with the first virtual object is received. The object control element is configured to cause the first virtual object to interact with the element decoration area in the virtual scene. Based on the object control operation performed on the object control element, the first virtual object decorated with a first virtual element is output for display. The first virtual element includes a virtual decoration element determined based on the object control operation causing interaction of the first virtual object with the element decoration area.

### RELATED APPLICATIONS

The present application is a continuation of International Application No. PCT/CN2024/120605, filed on September 24, 2024, which claims priority to Chinese Patent Application No. 202311790767.4, filed on December 21, 2023. The entire disclosures of the prior applications are hereby incorporated by reference.

### FIELD OF THE TECHNOLOGY

Aspects of this disclosure relate to the technical field of computers, including a virtual element decoration method.

### BACKGROUND OF THE DISCLOSURE

With the improvement of cultural and entertainment living standards, people's expectations and demands for virtual world experiences are also increasing. As a manifestation of the virtual world, games have become a channel for many people to release pressure. In the current game applications, a player may decorate a virtual object with various virtual elements. For example, the player may decorate the virtual object with a virtual costume.

In related art, if the players intend to decorate the virtual object with the virtual costume, they usually need to enter a virtual mall. In the virtual mall, they first select the virtual costume, and then view, by purchasing or previewing and trying, an effect that the virtual object wears the virtual costume. However, in the foregoing process, operations of decorating the virtual object with a virtual element by the player are relatively complex, resulting in relatively low human-computer interaction efficiency.

### SUMMARY

Aspects of this disclosure provide a virtual element decoration method, an information processing apparatus, and a non-transitory computer-readable storage medium. Examples of technical solutions of this disclosure may be implemented as follows:

An aspect of this disclosure provides a virtual element decoration method. In the method, a first virtual object and an element decoration area are output for display in a virtual scene. The element decoration area includes a region with an element decoration function. The element decoration function is configured to provide a decoration for the first virtual object. An object control operation performed on an object control element associated with the first virtual object is received. The object control element is configured to cause the first virtual object to interact with the element decoration area in the virtual scene. Based on the object control operation performed on the object control element, the first virtual object decorated with a first virtual element is output for display. The first virtual element includes a virtual decoration element determined based on the object control operation causing interaction of the first virtual object with the element decoration area.

An aspect of this disclosure provides an information processing apparatus. The apparatus includes processing circuitry configured to output for display a first virtual object and an element decoration area in a virtual scene. The element decoration area includes a region with an element decoration function. The element decoration function is configured to provide a decoration for the first virtual object. The processing circuitry is configured to receive an object control operation performed on an object control element associated with the first virtual object. The object control element is configured to cause the first virtual object to interact with the element decoration area in the virtual scene. The processing circuitry is configured to output for display, based on the object control operation performed on the object control element, the first virtual object decorated with a first virtual element. The first virtual element includes a virtual decoration element determined based on the object control operation causing interaction of the first virtual object with the element decoration area.

An aspect of this disclosure provides a virtual element decoration method, performed by a computer device and includes the following operations: displaying a first virtual object and an element decoration area located in a virtual scene, the element decoration area including an area providing an element decoration function, and the element decoration function being configured for providing a decoration for the first virtual object; receiving an object control operation for the first virtual object, the object control operation being configured for controlling the first virtual object to interact with the element decoration area in the virtual scene; and displaying, in response to the object control operation, the first virtual object decorated with a first virtual element, the first virtual element being a virtual decoration element determined based on the object control operation and the element decoration area.

An aspect of this disclosure provides a virtual element decoration apparatus, including: a display module, configured to display a first virtual object and an element decoration area located in a virtual scene, the element decoration area including an area providing an element decoration function, and the element decoration function being configured for providing a decoration for the first virtual object; and a receiving module, configured to receive an object control operation for the first virtual object, the object control operation being configured for controlling the first virtual object to interact with the element decoration area in the virtual scene, the display module being configured to display, in response to the object control operation, the first virtual object decorated with a first virtual element, the first virtual element being a virtual decoration element determined based on the object control operation and the element decoration area.

An aspect of this disclosure provides a computer device, including a processor and a memory, the memory having at least one instruction, at least one program, a code set, or an instruction set stored therein, the at least one instruction, the at least one program, the code set, or the instruction set being loaded and executed by the processor to implement the virtual element decoration methods according to any one of the foregoing aspects.

An aspect of this disclosure provides a non-transitory computer-readable storage medium storing instructions which, when executed by a processor, cause the processor to implement the virtual element decoration methods according to any one of the foregoing aspects.

An aspect of this disclosure provides a computer program product or a computer program, including computer instructions, the computer instructions being stored in the computer-readable storage medium. A processor of a computer device reads the computer instructions from the computer-readable storage medium and executes the computer instructions to cause the computer device to perform the virtual element decoration methods according to any one of the foregoing aspects.

The technical solutions provided in the aspects of this disclosure produce at least the following beneficial effects.

The element decoration area having the element decoration function is set in the virtual scene, and when a player controls a virtual object to interact with the element decoration area in the virtual scene, the virtual object is decorated with a virtual element. Using the element decoration area displayed in the virtual scene, the player may directly decorate the virtual object with the virtual element in the virtual scene, so that a complex operation of triggering an additional decoration page (for example, a virtual mall interface in related art) and then decorating the virtual object by the player is avoided, thereby significantly improving efficiency of decorating the virtual object with the virtual element, and improving human-computer interaction efficiency. In addition, after the virtual object is decorated with the virtual element, the virtual object is displayed in the virtual scene as an image decorated with the virtual element, so that other players can view a decoration effect of the virtual object, thereby enriching interestingness and diversity of a game.

### BRIEF DESCRIPTION OF THE DRAWINGS

FIG. 1 is a structural block diagram of an electronic device according to an aspect of this disclosure.

FIG. 2 is a structural block diagram of a computer system according to an aspect of this disclosure.

FIG. 3 is a flowchart of a virtual element decoration method according to an aspect of this disclosure.

FIG. 4 is a flowchart of a virtual element decoration method according to another aspect of this disclosure.

FIG. 5 is a schematic diagram of an interface of a virtual scene according to an aspect of this disclosure.

FIG. 6 is a schematic diagram of an interface of a virtual scene according to another aspect of this disclosure.

FIG. 7 is a schematic diagram of an interface of a preview sub-area and a decoration sub-area according to an aspect of this disclosure.

FIG. 8 is a schematic diagram of an interface of a plurality of decoration areas according to an aspect of this disclosure.

FIG. 9 is a schematic diagram of an interface of a plurality of decoration areas according to another aspect of this disclosure.

FIG. 10 is a schematic diagram of an interface of performing an object control operation according to an aspect of this disclosure.

FIG. 11 is a schematic diagram of an interface of a decoration scene zone according to an aspect of this disclosure.

FIG. 12 is a schematic diagram of an interface of a decoration scene zone according to another aspect of this disclosure.

FIG. 13 is a schematic diagram of an interface of a first virtual object decorated with a first virtual element according to an aspect of this disclosure.

FIG. 14 is a flowchart of a virtual element decoration method according to still another aspect of this disclosure.

FIG. 15 is a schematic diagram of an interface of a preset decoration duration according to an aspect of this disclosure.

FIG. 16 is a schematic diagram of an interface of a preset decoration duration according to another aspect of this disclosure.

FIG. 17 is a schematic diagram of an interface in related art according to an aspect of this disclosure.

FIG. 18 is a schematic diagram of an interface in related art according to another aspect of this disclosure.

FIG. 19 is a technical flowchart of performing a virtual element decoration method by a costume preview and wearing model according to an aspect of this disclosure.

FIG. 20 is a structural block diagram of a virtual element decoration apparatus according to an aspect of this disclosure.

FIG. 21 is a structural block diagram of an electronic device according to an aspect of this disclosure.

### DETAILED DESCRIPTION

First, terms involved in the aspects of this disclosure are briefly introduced. The descriptions of the terms are provided as examples and are not intended to limit the scope of the disclosure.

Virtual scene: The virtual scene is displayed (or provided) when an application program is run on a terminal. The virtual scene may be a simulated scene of a real scene, may be a semi-simulated and semi-fictional virtual scene, or may be a fictional virtual scene. The virtual scene may be any one of a two-dimensional virtual scene, a 2.5-dimensional virtual scene, and a three-dimensional virtual scene. This is not limited in this disclosure. The following aspects are described using an example in which the virtual scene is the three-dimensional virtual scene.

Virtual model: The virtual model is a model configured to imitate a real scene in a virtual scene. For example, the virtual model occupies a volume in the virtual scene. For example, the virtual model includes: a terrain model, a building model, an animal and plant model, a virtual prop model, a virtual vehicle model, and a virtual object model. For example, the terrain model includes: a ground, a mountain, a water stream, a stone, a step, and the like. The building model includes: a house, an enclosure, a container, and fixed facilities inside a building: a desk, a chair, a cabinet, a bed, and the like. The animal and plant model includes: a tree, a flower, a flying bird, and the like. The virtual prop model includes: a virtual attack prop, a medicine box, an aerial delivery, and the like. The virtual vehicle model includes an automobile, a ship, a copter, and the like. The virtual object model includes: a person, an animal, an animated person, and the like.

Virtual character/virtual object: The virtual character/virtual object is a movable object in a virtual scene. The movable object may be a virtual object, a virtual animal, an animated person, or the like, for example, a person, an animal, a plant, an oil drum, a wall, or a stone displayed in a three-dimensional virtual scene. In some aspects, the virtual object is a three-dimensional model created based on a skeletal animation technology. Each virtual object has a shape and a volume in the three-dimensional virtual scene, and occupies a part of space in the three-dimensional virtual scene.

The virtual element decoration method provided in this disclosure is applied to at least one of a plurality of virtual scenes such as a virtual shooting scene and a virtual battle scene. The foregoing application scenes are merely examples, and the virtual element decoration method provided in this aspect may alternatively be applied to another scene. These are not limited in the aspects of this disclosure.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

In some aspects, the virtual element decoration method is provided in this disclosure is performed by a computer device. The computer device may by a terminal. The terminal in this disclosure may be a desktop computer, a laptop computer, a mobile phone, a tablet computer, an e-book reader, a moving picture experts group audio layer III (MP3) player, a moving picture experts group audio layer IV (MP4) player, or the like. An application program supporting a virtual environment (that is, a virtual scene), for example, an application program supporting a three-dimensional virtual environment, is installed and run on the terminal. The application program may be any one of a virtual reality (VR) application program, a three-dimensional map program, a third-person shooting (TPS) game, a first-person shooting (FPS) game, and a multiplayer online battle arena (MOBA) game. In some aspects, the application program may be a standalone application program, such as a standalone three-dimensional game program; or may be a network-connected application program.

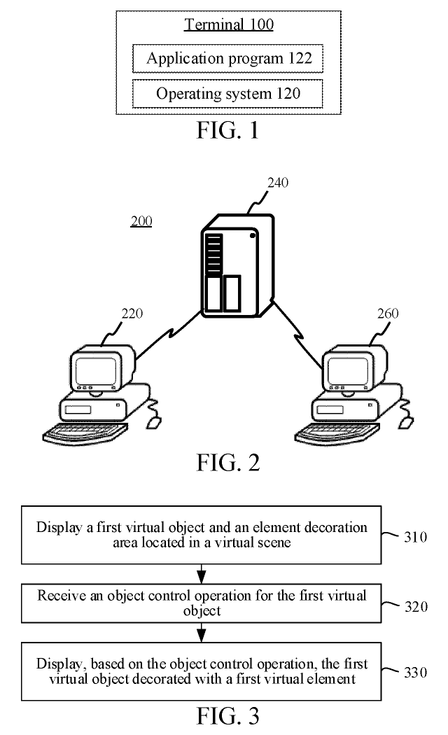

FIG. 1 is a structural block diagram of an electronic device according to an aspect of this disclosure. An electronic device 100 includes an operating system 120 and an application program 122. The electronic device 100 may be implemented as a computer device for performing a virtual element decoration method.

The operating system 120 is basic software provided for the application program 122 to perform secure access to computer hardware. The application program 122 is an application program supporting a virtual environment. In some aspects, the application program 122 is an application program supporting a three-dimensional virtual environment.

FIG. 2 is a structural block diagram of a computer system according to an aspect of this disclosure. A computer system 200 includes a first device 220, a server 240, and a second device 260. In some aspects, the first device 220 or the second device 260 may be implemented as a computer device for performing a virtual element decoration method.

An application program supporting a virtual environment is installed and run on the first device 220. The first device 220 is a device used by a first user. The first user uses the first device 220 to control the first virtual object in the virtual environment to perform an activity. The activity includes, but is not limited to, at least one of adjusting body postures, crawling, walking, running, riding, jumping, driving, picking, shooting, attacking, and throwing. For example, the first virtual object is a first virtual person such as a simulated person character or an animated person character. The first device 220 is connected to the server 240 using a wireless network or a wired network.

The server 240 includes at least one of one server, a plurality of servers, a cloud computing platform, and a virtualization center. The server 240 is configured to provide a background service for an application program supporting a three-dimensional virtual environment. In some aspects, the server 240 undertakes main computing work, and a first terminal 220 and a second terminal 260 undertake secondary computing work. Alternatively, the server 240 undertakes secondary computing work, and the first terminal 220 and the second terminal 260 undertake main computing work. Alternatively, the server 240, the first terminal 220, and the second terminal 260 perform collaborative computing using a distributed computing architecture.

An application program supporting a virtual environment is installed and run on the second device 260. The second device 260 is a device used by a second user. The second user uses the second device 260 to control a second virtual object in the virtual environment to perform an activity. The activity includes, but is not limited to, at least one of adjusting body postures, crawling, walking, running, riding, jumping, driving, picking, shooting, attacking, and throwing. For example, the second virtual object is a second virtual person such as a simulated person character or an animated person character. In some aspects, the first virtual person and the second virtual person are located in the same virtual environment. In some aspects, the first virtual person and the second virtual person may belong to the same team or the same organization, have a friend relationship, or have a temporary communication permission. In some aspects, the first virtual person and the second virtual person may alternatively belong to different teams, different organizations, or two groups hostile to each other. In some aspects, the application programs installed on the first device 220 and the second device 260 are the same, or the application programs installed on the two devices are the same type of application programs of different control system platforms. The first device 220 may refer to one of a plurality of devices, and the second device 260 may refer to one of a plurality of devices. In this aspect, description is made using only the first device 220 and the second device 260 as an example. A device type of the first device 220 and a device type of the second device 260 may be the same or may be different. The device type includes at least one of a game console, a desktop computer, a smartphone, a tablet computer, an e-book reader, an MP3 player, an MP4 player, and a laptop computer.

It is noted that more or fewer devices may be used. For example, only one device may be used, or dozens of or hundreds of or more devices may be used. The quantity and the device type of the devices are not limited in the aspects of this disclosure. The server 240 may be implemented as a physical server, may be implemented as a cloud server in a cloud, and may alternatively be implemented as a node in a blockchain system.

In some aspects, the method provided in the aspects of this disclosure may be applied to a cloud game scene, so as to complete computing of data logic in a game process by a cloud server, and a terminal is responsible for displaying a game interface.

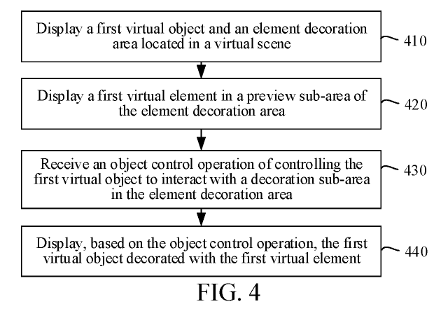

With reference to the brief introduction of terms and application scenes, the virtual element decoration method provided in this disclosure is described. The method is performed by a computer device, and is described using an example in which the computer device is implemented as a server. As shown in FIG. 3, the method includes the following operation 310 to operation 330.

Operation 310: Display a first virtual object and an element decoration area located in a virtual scene. For example, a first virtual object and an element decoration area are output for display in a virtual scene. The element decoration area includes a region with an element decoration function. The element decoration function is configured to provide a decoration for the first virtual object.

In some aspects, the virtual scene is a scene displayed when an application program runs on a terminal device. The virtual scene may be a simulated environment in the real world. For example, the virtual scene is a scene built based on the real world and obtained after simulation is performed to the real world. Alternatively, the virtual scene may be a semi-simulated and semi-fictional scene. For example, the virtual scene includes a scene existing in the real world (for example, traffic and a road) and a fictional scene (for example, an island A and a volcano B that do not exist in the real world). Alternatively, the virtual scene may be a pure fictional scene. For example, scenes, things, and the like in the virtual scene do not correspondingly exist in the real world (such as a monster and a demon). In some aspects, the virtual scene is at least one of a two-dimensional virtual scene, a 2.5-dimensional virtual scene, and a three-dimensional virtual scene. In a virtual scene loading process, a process of switching from a two-dimensional virtual scene to a three-dimensional virtual scene may exist, or a process of switching from a three-dimensional virtual scene to a two-dimensional virtual scene may exist. For example, the virtual scene may include the sky, the land, the ocean, and the like. The land may include an environment element such as grassland, a desert, and a city, and a user may control a virtual object to move in the virtual scene.

In some aspects, the virtual object is an image of various people and objects that may perform interaction within the virtual scene, or a movable object in the virtual scene. The movable object may be a virtual person, a virtual animal, an animated person, or the like. For example, the virtual object may be a virtual image representing a player in the virtual scene. Alternatively, the virtual object may be a non-player character (NPC) such as a wild monster or a world boss. For example, the virtual scene includes a plurality of virtual objects, and the first virtual object is any virtual object controlled by the player in the plurality of virtual objects. For example: the player controls the first virtual object to perform actions such as walking, running, jumping, and shooting in a virtual scene.

For example, the element decoration area is an area that exists in the virtual scene and is configured to perform an element decoration process. In some aspects, the element decoration area is implemented as a virtual fitting room. Alternatively, the element decoration area is implemented as a virtual decoration wall. Alternatively, the element decoration area is implemented as a defined area in a virtual scene, or the like.

The element decoration area includes an area providing an element decoration function, and the element decoration function is configured for providing a decoration for the first virtual object. In some aspects, the element decoration area includes a plurality of decoration areas, and each decoration area is configured to decorate at least one virtual element. In some aspects, the element decoration area provides a plurality of functions. The plurality of functions include at least one of an element decoration function, an element preview function, an element configuration function, and the like. For example, the element decoration function is configured for providing a decoration for a virtual object in the virtual scene through the element decoration area. The element configuration function is configured for configuring a virtual element associated with the decoration. The element preview function is configured for previewing the virtual element associated with the decoration, and the like.

Operation 320: Receive an object control operation for the first virtual object. For example, an object control operation performed on an object control element associated with the first virtual object is received. The object control element is configured to cause the first virtual object to interact with the element decoration area in the virtual scene.

For example, in addition to displaying the first virtual object, an operation of controlling, by the player using the terminal, the first virtual object to perform a specific behavior, which is referred to as the object control operation, is received.

The object control operation is configured for controlling the first virtual object to interact with the element decoration area in the virtual scene. For example, the player may control the first virtual object to perform a moving operation such as walking or running in the virtual scene, control the first virtual object to perform an attacking operation such as punching, shooting, or activating an ultimate skill in the virtual scene, or control the first virtual object to perform an operation of using a virtual tool such as driving a vehicle or skateboarding in the virtual scene.

In some aspects, the object control operation is configured for decorating the first virtual object with an element. After determining that the virtual scene includes the first virtual object and the element decoration area, based on an element decoration effect of the element decoration area, the player may control the first virtual object to interact with the element decoration area, so as to apply the element decoration function to the first virtual object.

In some aspects, an operation form of the object control operation is determined based on the object decoration area, that is, an interaction form between the first virtual object and the element decoration area is determined. In some aspects, the element decoration area is a three-dimensional space area in the virtual scene, and the object control operation is configured for controlling the first virtual object to move to interact with the three-dimensional space area in which the element decoration area is located. For example, the player may control the first virtual object to move to cause the first virtual object to interact with the three-dimensional space area in which the element decoration area is located. For example, a form of controlling the first virtual object to move to interact with the three-dimensional space area in which the element decoration area is located is implemented as at least one of the following forms.

### The first virtual object passes through the element decoration area

In some aspects, the element decoration area is a three-dimensional space area having an entrance and an exit. When the first virtual object passes through the entrance of the area and moves in the area until the first virtual object passes through the exit, a process of passing through the element decoration area is completed. For example, the element decoration area is implemented as an area such as a virtual decoration wall, a virtual fitting room, or a virtual costume changing tunnel. The player controls the first virtual object to pass through the element decoration area, that is, the player controls the first virtual object to interact with the element decoration area.

### The first virtual object is located in the element decoration area

For example, the element decoration area is implemented as a specified area in the virtual scene. The player controls the first virtual object to enter the element decoration area, that is, the player controls the first virtual object to interact with the element decoration area.

The element decoration area may be implemented as a virtual display area, a virtual room, a virtual show field, or the like. This is not limited herein.

The foregoing element decoration area is different from the following three-dimensional model of the first virtual element. In the aspects of this disclosure, interaction between the first virtual object and the element decoration area is area-based interaction, rather than interaction based on the three-dimensional model of the first virtual element. The foregoing examples of the form of controlling the first virtual object to move to interact with the three-dimensional space area in which the element decoration area is located are merely example descriptions, and are not limited in the aspects of this disclosure. For example, the player controls the first virtual object to smoothly surround the element decoration area, that is, the player controls the first virtual object to interact with the element decoration area. Alternatively, the player controls the first virtual object to fly or hover above the element decoration area, that is, the player controls the first virtual object to interact with the element decoration area. Alternatively, the element decoration area is disposed at a height in the virtual scene, the player controls the first virtual object to jump or climb to the element decoration area, that is, the player controls the first virtual object to interact with the element decoration area. In the foregoing aspect, the element decoration area is set as the three-dimensional space area, and the element decoration area is used as a medium for interacting with the first virtual object. The three-dimensional space area provides the player with an intuitive space feeling. The player can see a position and a range of the element decoration area in the virtual scene, thereby reducing a possibility of an operational error. The player can more rapidly and accurately complete an interaction operation with the element decoration area, thereby improving efficiency of human-computer interaction.

Operation 330: Display, based on the object control operation, the first virtual object decorated with the first virtual element. For example, based on the object control operation performed on the object control element, the first virtual object decorated with a first virtual element is output for display. The first virtual element includes a virtual decoration element determined based on the object control operation causing interaction of the first virtual object with the element decoration area.

In some aspects, the first virtual object decorated with the first virtual element is displayed in response to the object control operation.

For example, after the object control operation is received, based on the element decoration function corresponding to the element decoration area, the first virtual object interacting with the element decoration area is decorated with an element. The first virtual element is a virtual decoration element determined based on the object control operation and the element decoration area. In some aspects, the virtual decoration element is configured to indicate a decorative item wearable on the first virtual object. The virtual decoration element may be configured to change an appearance of the first virtual object. Element types of the virtual decoration element include a virtual costume, a virtual accessory, virtual equipment, a virtual makeup (such as a hair style and a face shape), a virtual facial ornament (such as glasses and a mask), a virtual special effect (such as a virtual light ring and a virtual wing), and a virtual skin. This is not limited herein.

For example, when the first virtual object is decorated with the first virtual element using the element decoration function corresponding to the element decoration area, interaction between the first virtual object and the element decoration area is instructed based on the object control operation, to decorate the first virtual element on the first virtual object. For example, the first virtual element is a virtual skin A, and the first virtual object is controlled to interact with the element decoration area based on the object control operation, so as to decorate the virtual skin A on the first virtual object.

In some aspects, the element decoration function is configured for providing trying on of a virtual decoration element for the first virtual object. That is, the element decoration function enables the player to preview a visual effect of trying on the virtual decoration element by the first virtual object.

In some aspects, the first virtual object decorated with the first virtual element in a try-on mode is displayed in response to the object control operation.

In some aspects, the try-on mode refers to a mode in which the first virtual object is temporarily decorated with the first virtual element. For example, after the element decoration function of the element decoration area is triggered in response to the object control operation, a decoration effect of the first virtual object trying on the first virtual element is displayed, and after a preset decoration duration is reached, the decoration effect of the first virtual object not decorated with the first virtual element. In some aspects, the preset decoration duration is a duration restriction that is set in advance, and is configured for limiting a duration for which the first virtual element is decorated on the first virtual object. For example, the preset decoration duration is a fixed value, such as one minute. Alternatively, the preset decoration duration is a value determined according to an object level of the first virtual object. For example, if the object level of the first virtual object is higher, the preset decoration duration is longer, and if the object level of the first virtual object is lower, the preset decoration duration is shorter.

In the foregoing aspect, the try-on experience of the first virtual element for a limited duration is provided using the try-on mode, so that the player can instantly preview an effect of the first virtual element on the first virtual object. In addition, by setting the preset decoration duration, resource consumption in a try-on process can be effectively controlled, thereby avoiding excessive occupation of server resources.

In some other aspects, the try-on mode refers to a mode of a partial decoration effect in which the first virtual object is decorated with the first virtual element. For example, using an example in which the first virtual element is implemented as a virtual costume, the virtual costume tried on by the first virtual object is a simplified version of virtual costume, and the simplified version of virtual costume may include only a main feature or a key part of the original virtual costume, allowing the player to quickly know an overall style and characteristic of the costume. After the first virtual object redeems the virtual costume, the virtual costume decorated on the first virtual object is a complete version of virtual costume.

In the foregoing aspect, a partial decoration effect of the first virtual element is provided using the try-on mode, so that resource consumption and loading time in a try-on process of the first virtual object are reduced, and the player can preview an element decoration effect more quickly.

In some aspects, a plurality of virtual elements are provided in the element decoration area. Element types of the plurality of virtual elements may be the same or may be different. For example, the plurality of virtual elements may be implemented as a virtual costume 1 and a virtual costume 2. Alternatively, the plurality of virtual elements may be implemented as a virtual costume 1 and a virtual necklace 1.

In some aspects, the first virtual object decorated with the first virtual element is randomly displayed in response to the object control operation, and the first virtual element is an element randomly determined in a plurality of virtual elements. For example, an example in which the element decoration area is implemented as a virtual decoration wall is used. When the player controls the first virtual object to pass through the virtual decoration wall, at least one virtual element in the plurality of virtual elements is randomly determined to be decorated on the first virtual object. In the foregoing aspect, because the first virtual element is randomly determined, the player may obtain different decoration effects each time passing through the virtual decoration wall. This increases a sense of surprise and exploration of the game.

Alternatively, in response to the object control operation, the first virtual object decorated with the first virtual element is displayed based on stay duration of the first virtual object in the element decoration area, and the first virtual element is an element determined in a plurality of virtual elements according to the stay duration. For example, an example in which the element decoration area is implemented as a decoration scene zone is used. When the player controls the first virtual object to enter the decoration scene zone, the virtual object is decorated according to display duration of the first virtual object in the decoration scene zone. For example, when duration for which the player stays in the decoration scene zone reaches one second, the virtual costume 1 is worn by the first virtual object. When the duration for which the player stays in the decoration scene zone reaches five seconds, the virtual costume 1 worn by the first virtual object is switched to the virtual costume 2. Alternatively, when duration for which the player stays in the decoration scene zone reaches one second, the virtual costume 1 is worn by the first virtual object. When the duration for which the player stays in the decoration scene zone reaches five seconds, the virtual necklace 1 is worn by the first virtual object. In this case, the first virtual object displayed in the virtual scene wears the virtual costume 1 and the virtual necklace 1. In the foregoing aspect, in the element decoration area, different stay durations correspond to different decoration effects, and a decoration change is automatically triggered by setting the stay duration, thereby reducing manual operations of the player, and improving efficiency of human-computer interaction.

In some aspects, the first virtual element is previewed and displayed in the element decoration area. An object control operation of controlling the first virtual object to interact with the first virtual element displayed in the element decoration area is received. The first virtual object decorated with the first virtual element is displayed in response to the object control operation. For example, the virtual costume is displayed in a preview sub-area of the element decoration area, and when the first virtual object passes through a virtual costume display position, a decoration effect of the first virtual object wearing the virtual costume is displayed.

In some aspects, the element decoration area includes the preview sub-area and a decoration sub-area, the preview sub-area is configured to preview the first virtual element, and the decoration sub-area is configured to decorate the first virtual object with the first virtual element displayed in the preview sub-area during interaction with the first virtual object.

For example, the virtual costume is displayed in the preview sub-area of the element decoration area, and when the first virtual object passes through the decoration sub-area or when the first virtual object is in the decoration sub-area, a decoration effect of the first virtual object wearing the virtual costume is displayed.

In summary, using the element decoration area displayed in the virtual scene, the player may directly decorate the virtual object with the virtual element in the virtual scene, so that a complex operation of triggering an additional decoration page (for example, a virtual mall interface in related art) and then decorating the virtual object by the player is avoided, thereby significantly improving efficiency of decorating the virtual object with the virtual element, and improving efficiency of human-computer interaction. In addition, after the virtual object is decorated with the virtual element, the virtual object is displayed in the virtual scene as an image decorated with the virtual element, so that other players can view a decoration effect of the virtual object, thereby enriching interestingness and diversity of a game.

In addition, in related art, when a virtual mall is started, a large quantity of decoration resources need to be acquired to display the corresponding virtual decoration resources in the virtual mall. However, according to the virtual element decoration method provided in this disclosure, the large quantity of decoration resources do not need to be loaded and displayed in the element decoration area, thereby reducing resource transmission consumption between a server and a terminal.

In an aspect, the element decoration area includes a preview sub-area and a decoration sub-area. The virtual element can be previewed using the preview sub-area, and a process of decorating the virtual element can be performed using the decoration sub-area. For example, as shown in FIG. 4, the aspect shown in FIG. 3 may alternatively be implemented as the following operation 410 to operation 440.

Operation 410: Display a first virtual object and an element decoration area located in a virtual scene. For example, a first virtual object and an element decoration area are output for display in a virtual scene. The element decoration area includes a region with an element decoration function. The element decoration function is configured to provide a decoration for the first virtual object.

The element decoration area includes an element decoration function, and the element decoration function is configured for providing a decoration for the first virtual object. For example, the element decoration function is configured for decorating the first virtual element on the first virtual object to preview a decoration effect of the first virtual object decorated with the first virtual element.

In some aspects, the element decoration area includes at least one of a virtual decoration wall, a decoration scene zone, and the like.

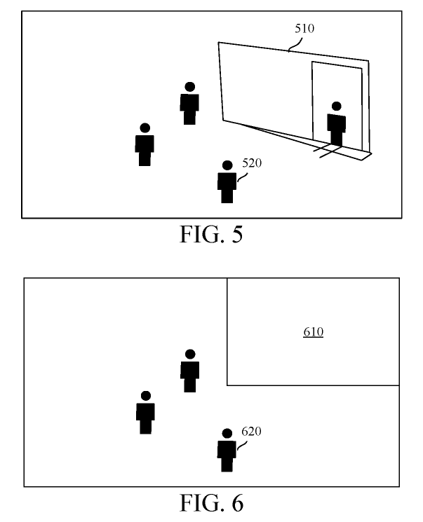

In an aspect, the element decoration area is a virtual decoration wall set in the virtual scene. For example, the virtual decoration wall is a virtual medium set in the virtual scene. In some aspects, the quantity of the virtual decoration wall in the virtual scene may be one or more. In some aspects, the virtual decoration wall may be a wall element of an independent reality in the virtual scene, or may be a wall element of a virtual building in the virtual scene. This is not limited herein. In some aspects, the virtual decoration wall is content displayed by holographic projection. For example, if a position A of holographic projection of the virtual decoration wall in the virtual scene is set, the virtual decoration wall is displayed at the position A in the virtual scene. Alternatively, the virtual decoration wall is content displayed after a function of content such as a virtual building is triggered. For example, if a virtual building B is displayed in the virtual scene, and the virtual building B includes a plurality of virtual walls, the player may adjust, based on a game process, a virtual wall b of the plurality of virtual walls into a virtual decoration wall. FIG. 5 is a schematic diagram of an interface of a virtual scene. A plurality of virtual objects are displayed, and a virtual decoration wall 510 (that is, an element decoration area) is further displayed. Using an example in which any virtual object 520 in the plurality of virtual objects is the first virtual object, the player may decorate the virtual object 520 with a virtual element using a virtual decoration function corresponding to the element decoration area by controlling the virtual object 520.

For example, a position of the virtual decoration wall in the virtual scene may be fixed, or may be configured by the player, or may be adjusted by the player based on the game process. This is not limited herein.

In an aspect, the element decoration area is a decoration scene zone set in the virtual scene, and the decoration scene zone is configured to indicate a scene area within a preset range of the virtual scene. For example, the decoration scene zone is a scene area set in the virtual scene. For example, the virtual scene is a three-dimensional virtual space, and the virtual scene area is a three-dimensional virtual space within a preset range of the virtual scene. The preset range is a range that is set in advance, and a shape of the preset range may be a circle, a rectangle, an irregular shape, or the like. The shape and a size of the preset range are not limited in the aspects of this disclosure. In some aspects, the shape and the size of the preset range are a shape and a size of the decoration scene zone. In some aspects, the decoration scene zone is a circular area defined using a point in the virtual scene as a center and a fixed length as a radius. Alternatively, the virtual scene area is a rectangular area that uses a point in the virtual scene as a center and has a fixed length as a side or a diagonal. For example, the decoration scene zone is a scene area defined in advance by a game background. Alternatively, the decoration scene zone is a scene area obtained through expansion based on a game process.

In some aspects, the decoration scene zone is an unattributed scene area in the virtual scene. For example, the decoration scene zone is a public space in the virtual scene. Alternatively, the decoration scene zone is a scene area belonging to a virtual object in the virtual scene. For example, the decoration scene zone is a personal virtual room of a player.

FIG. 6 is a schematic diagram of an interface of a virtual scene. A plurality of virtual objects are displayed, and a decoration scene zone 610 (that is, an element decoration area) is further displayed. Using an example in which any virtual object 620 in the plurality of virtual objects is the first virtual object, the player may decorate the virtual object 620 with an element using a virtual decoration function corresponding to the element decoration area by controlling the virtual object 620.

The foregoing implementation of the element decoration area as a virtual decoration wall or a decoration scene zone is merely an example. The element decoration area may alternatively be implemented in a plurality of forms existing in the virtual scene such as a virtual fitting room. This is not limited herein.

In some aspects, the element decoration area includes a preview sub-area and a decoration sub-area, an effect of the virtual element can be previewed using the preview sub-area, and an element decoration process can be performed for a virtual object using the decoration sub-area.

Operation 420: Display the first virtual element in the preview sub-area of the element decoration area. For example, the element decoration area includes a preview sub-area and a decoration sub-area. The preview sub-area is configured to display a preview of the first virtual element.

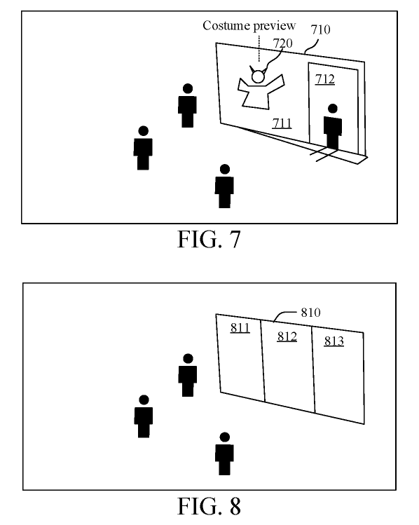

In some aspects, the element decoration area corresponds to the first virtual element. When the element decoration area is displayed, the first virtual element is displayed in the preview sub-area of the element decoration area. Using the preview sub-area, the player can learn an appearance effect of the current to-be-decorated virtual element before decorating the virtual object, thereby reducing operational errors caused by blind selection, and avoiding unnecessary resource waste and time consumption. As shown in FIG. 7, the element decoration area is implemented as a virtual decoration wall 710, including a preview sub-area 711 and a decoration sub-area 712. The first virtual element 720 is displayed in the preview sub-area 711, and is configured to preview an effect of the first virtual element 720.

In some aspects, the element decoration area corresponds to a plurality of virtual elements, and the first virtual element is a virtual element configured and determined in the plurality of virtual elements at the current moment. For example, the element decoration area is configured to present a hot virtual element in time. Based on configuration of a game background or popularity of the game background for the plurality of virtual elements, at least one virtual element is determined from the plurality of virtual elements as the first virtual element. The popularity may be determined according to a quantity of times of viewing, purchasing, using, or sharing the virtual element. A larger quantity of times of viewing, purchasing, using, or sharing indicates higher popularity. Alternatively, the first virtual object is a virtual object associated with a first account. That is, if the player controls the first virtual object using the first account, at least one virtual element in the plurality of virtual elements is determined as the first virtual element according to a decoration preference corresponding to the first account. For example, if the plurality of virtual elements refer to virtual costumes, and the decoration preference corresponding to the first account is a retro costume, the retro costume is determined as the first virtual element in the plurality of virtual costumes.

For example, when the first virtual element is implemented as one virtual element in a plurality of virtual elements, with reference to the manner shown in FIG. 7, the first virtual element is represented using the preview sub-area 711 and the decoration sub-area 712.

For example, when the first virtual element is implemented as two or more virtual elements in a plurality of virtual elements, a decoration area may be determined for each first virtual element from the element decoration area. When the preview sub-area and the decoration sub-area are displayed, a corresponding preview sub-area and a corresponding decoration sub-area are displayed in each decoration area.

In an aspect, the element decoration area includes decoration areas corresponding to the plurality of virtual elements, respectively, including a first decoration area corresponding to the first virtual element. The element decoration area not only can be implemented as an area in which an element decoration process is performed using one virtual element, but also can be implemented as an area in which an element decoration process is performed using a plurality of virtual elements.

In some aspects, when the element decoration area is implemented as an area in which an element decoration process is performed using a plurality of virtual elements, the element decoration area is divided into a plurality of decoration areas. For example, the element decoration area includes a decoration area 1, a decoration area 2, and a decoration area 3. The decoration area 1 corresponds to a virtual element A, the decoration area 2 corresponds to a virtual element B, and the decoration area 3 corresponds to a virtual element C. If the first virtual element is the virtual element A, the first decoration area is the decoration area 1.

As shown in FIG. 8, the element decoration area is implemented as a virtual decoration wall 810, including a decoration area 811, a decoration area 812, and a decoration area 813. The decoration area 811 corresponds to a virtual element A and is configured to decorate a virtual object with the virtual element A. The decoration area 812 corresponds to a virtual element B and is configured to decorate a virtual object with the virtual element B. The decoration area 813 corresponds to a virtual element C and is configured to decorate a virtual object with the virtual element C.

In some aspects, a decoration area includes a preview sub-area and a decoration sub-area, and the preview sub-area is configured to preview a virtual element corresponding to the decoration area. The decoration sub-area is configured to apply a virtual element corresponding to the decoration area to a virtual object.

For example, each decoration area includes a preview sub-area and a decoration sub-area, and a virtual element correspondingly represented by the preview sub-area and the decoration sub-area included in the decoration area is determined based on a correspondence between the decoration area and the virtual element.

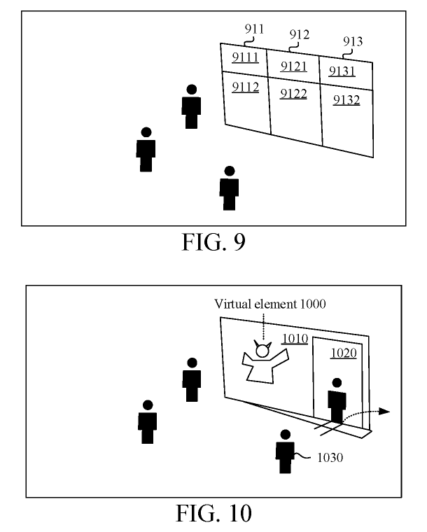

As shown in FIG. 9, the element decoration area is implemented as a virtual decoration wall, including a decoration area 911, a decoration area 912, and a decoration area 913. The decoration area 911 corresponds to a virtual element A and includes a preview sub-area 9111 and a decoration sub-area 9112. The decoration area 912 corresponds to a virtual element B and includes a preview sub-area 9121 and a decoration sub-area 9122. The decoration area 913 corresponds to a virtual element C and includes a preview sub-area 9131 and a decoration sub-area 9132. The preview sub-area 9111 is configured to preview a decoration effect of the virtual element A, and the decoration sub-area 9112 is configured to apply the virtual element A to a virtual object. Similarly, the preview sub-area 9121 is configured to preview a decoration effect of the virtual element B, and the decoration sub-area 9122 is configured to apply the virtual element B to a virtual object. The foregoing is merely an example, and the decoration area may alternatively be implemented as an area that does not include the preview sub-area and is used only for decorating the virtual element. This is not limited herein.

Operation 430: Receive an object control operation of controlling the first virtual object to interact with the decoration sub-area in the element decoration area. For example, an object control operation performed on an object control element associated with the first virtual object is received. The object control element is configured to cause the first virtual object to interact with the element decoration area in the virtual scene. In an example, the decoration sub-area is configured to decorate the first virtual object with the first virtual element displayed in the preview sub-area during the interaction with the first virtual object.

In an aspect, the element decoration area is a virtual decoration wall set in the virtual scene. A first moving operation for the first virtual object is received as the object control operation. The first moving operation is configured for controlling the first virtual object to pass through the virtual decoration wall in the virtual scene. For example, the virtual decoration wall is a virtual medium that can be passed through. The player controls the first virtual object to move in the virtual scene, and a moving operation of controlling the first virtual object to cross from one side of the virtual decoration wall to the other side is referred to as the object control operation. In some aspects, when controlling the first virtual object to interact with the element decoration area, the player performs a process of decorating the virtual element based on the decoration sub-area in the element decoration area. Therefore, the player can control interaction between the first virtual object and the decoration sub-area, to implement the object control operation on the first virtual object.

For example, the virtual decoration wall includes a preview sub-area and a decoration sub-area, the preview sub-area is a virtual medium on the virtual decoration wall that cannot be passed through, and the decoration sub-area is a virtual medium on the virtual decoration wall that can be passed through. The player controls the first virtual object to move in the virtual scene, and can control the first virtual object to perform a crossing moving process at the decoration sub-area, so that a moving operation performed in the crossing moving process of crossing from one side of the virtual decoration wall to the other side is referred to as the object control operation.

As shown in FIG. 10, the element decoration area is implemented as a virtual decoration wall, and the virtual decoration wall corresponds to a virtual element 1000. The virtual decoration wall includes a preview sub-area 1010 and a decoration sub-area 1020, the preview sub-area 1010 is configured to present the virtual element 1000, and the decoration sub-area 1020 is configured to decorate a virtual object with the virtual element 1000. Using an example in which the first virtual object is a virtual object 1030, the virtual object 1030 is controlled to pass through the decoration sub-area 1020 in the virtual scene, so as to decorate the virtual object 1030 with the virtual element 1000 corresponding to the virtual decoration wall.

In the foregoing aspect, the element decoration area is designed as a virtual decoration wall, and the player can decorate the virtual object with the virtual element only by controlling the virtual object to pass through the virtual decoration wall. This operation manner is simple and intuitive, and the player can implement the process of decorating the virtual object using only one operation, thereby improving efficiency of human-computer interaction.

In an aspect, the element decoration area is a decoration scene zone set in the virtual scene. A second moving operation for the first virtual object is received as the object control operation. The second moving operation is configured for controlling the first virtual object to move to the decoration scene zone. For example, the decoration scene zone is a part of scene area that can be entered in the virtual scene. The player controls the first virtual object to move in the virtual scene, and a moving operation of controlling the first virtual object to enter the decoration scene zone is referred to as the object control operation.

In some aspects, the decoration scene zone includes a preview sub-area and a decoration sub-area. The second moving operation of controlling the first virtual object to move to the decoration sub-area is received as the object control operation.

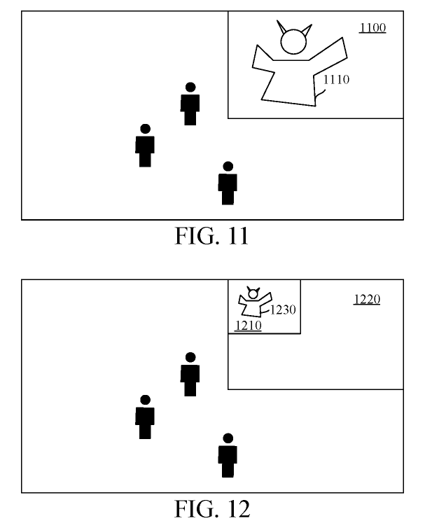

In some aspects, the preview sub-area and the decoration sub-area are implemented as overlapping areas. An overlapping degree between the preview sub-area and the decoration sub-area may be implemented as full overlapping or partial overlapping. For example, when the preview sub-area and the decoration sub-area are all implemented as full overlapping, the decoration scene zone may be referred to as the preview sub-area or may be implemented as the decoration sub-area. As shown in FIG. 11, the element decoration area is implemented as a decoration scene zone 1100, a preview sub-area and a decoration sub-area included in the decoration scene zone 1100 are full overlapping areas, and the decoration scene zone 1100 displays a preview effect of a virtual element 1110 based on a preview effect of the preview sub-area. The decoration scene zone 1100 can decorate a virtual object in the decoration scene zone 1100 with the virtual element 1110 based on a decoration effect of the decoration sub-area.

In some aspects, the preview sub-area and the decoration sub-area are implemented as relatively independent areas. The preview sub-area occupies one part of the decoration scene zone, and the decoration sub-area occupies another part of the decoration scene zone. For example, as shown in FIG. 12, the element decoration area is implemented as a decoration scene zone, the decoration scene zone includes a preview sub-area 1210 and a decoration sub-area 1220, and a preview effect of a virtual element 1230 is displayed in the preview sub-area 1210. The decoration sub-area 1220 decorates a virtual object in the decoration sub-area 1220 with the virtual element 1230 based on a decoration effect.

In some aspects, when the element decoration area includes decoration areas corresponding to a plurality of virtual elements, respectively, and each decoration area corresponds to a preview sub-area and a decoration sub-area, each decoration area may be considered as an element decoration area with reference to the foregoing content, and a preview effect and a decoration effect of each virtual element are performed. This is not limited herein.

In the foregoing aspect, the element decoration area is designed as a scene area in the virtual scene, and the virtual scene does not need to be additionally added with another special element to be used as a decoration area, thereby saving computer resources. The player only needs to move to a specified area in the virtual scene to decorate a virtual object with a virtual element. Such an intuitive operation manner reduces learning costs and improves efficiency of human-computer interaction.

Operation 440: Display, based on the object control operation, the first virtual object decorated with the first virtual element. For example, based on the object control operation performed on the object control element, the first virtual object decorated with a first virtual element is output for display. The first virtual element includes a virtual decoration element determined based on the object control operation causing interaction of the first virtual object with the element decoration area.

In some aspects, the first virtual object decorated with the first virtual element is displayed in response to the object control operation. The first virtual element is a virtual decoration element determined based on the object control operation and the element decoration area. For example, after the object control operation is received, the first virtual element is determined based on the object control operation and the element decoration area.

In some aspects, when the element decoration area corresponds to one virtual element, based on the object control operation and the element decoration area, the virtual element is determined as the first virtual element. In some aspects, when the element decoration area corresponds to a plurality of virtual elements, based on the object control operation and a decoration area in the element decoration area targeted by the object control operation, a virtual element corresponding to the decoration area is determined as the first virtual element. As shown in FIG. 8, the element decoration area is implemented as a virtual decoration wall 810, including a decoration area 811 corresponding to a virtual element A, a decoration area 812 corresponding to a virtual element B, and a decoration area 813 corresponding to a virtual element C. When an object control operation is received and the object control operation is determined as an operation performed for the decoration area 811, the virtual element A is used as the first virtual element.

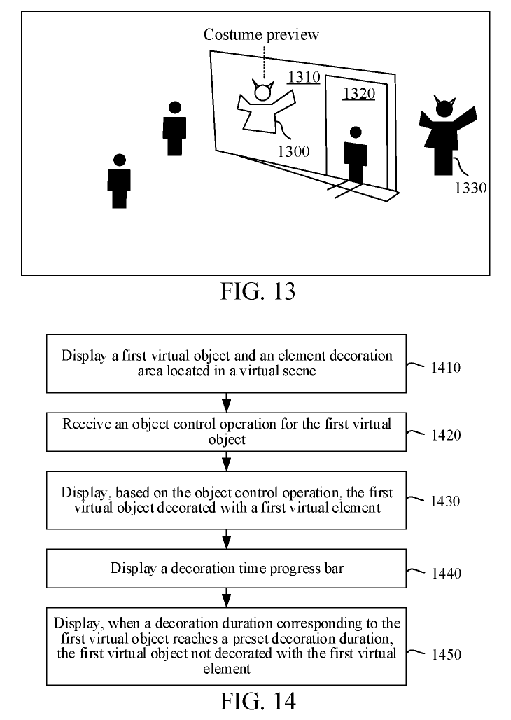

In some aspects, the first virtual element is applied to the first virtual object based on the object control operation and the determining of the first virtual element, to display the first virtual object to which the first virtual element is applied. As shown in FIG. 13, the element decoration area is implemented as a virtual decoration wall, and the virtual decoration wall corresponds to the first virtual element 1300. The virtual decoration wall includes a preview sub-area 1310 and a decoration sub-area 1320. The first moving operation of controlling the first virtual object 1330 to pass through the decoration sub-area 1320 is used as the object control operation, to apply the virtual element 1300 to the first virtual object 1330, so as to display the first virtual object 1330 decorated with the first virtual element 1300.

In some aspects, the element decoration area includes decoration areas corresponding to the plurality of virtual elements, respectively, including the first decoration area configured to decorate the first virtual element. In some aspects, in response to that the object control operation instructs the first virtual object to interact with the first decoration area in the element decoration area, the first virtual object decorated with the first virtual element is displayed. The element decoration area includes decoration areas corresponding to the plurality of virtual elements, respectively, including the first decoration area corresponding to the first virtual element. For example, an example in which the first virtual element is a virtual element A is used, and a decoration area corresponding to the virtual element A is the first decoration area. When the object control operation instructs the first virtual object to interact with the first decoration area, the virtual element decorated on the first virtual object is determined as the virtual element A, so that the first virtual object decorated with the virtual element A is displayed.

In some aspects, the first decoration area includes a first preview sub-area and a first decoration sub-area. The first preview sub-area is configured to preview the first virtual element. In some aspects, in response to that the object control operation instructs the first virtual object to interact with the first decoration sub-area, the first virtual object decorated with the first virtual element is displayed.

In the aspects of this disclosure, content including the preview sub-area and the decoration sub-area in the element decoration area is described. A status of decorating the virtual element can be previewed using the preview sub-area, and a virtual element decoration process can be performed using the decoration sub-area, so as to divide a function of the element decoration area more granularly, thereby facilitating a high-efficient decoration process while viewing the virtual element quickly. In addition, the element decoration area may alternatively be implemented as a plurality of decoration areas, the plurality of decoration areas correspond to different virtual elements, respectively, and the plurality of decoration areas may alternatively have corresponding preview sub-areas and decoration sub-areas, so that the plurality of virtual elements are managed and viewed in a uniform manner using the element decoration area, thereby further improving decoration efficiency of the virtual element and improving efficiency of human-computer interaction.

In an aspect, after the first virtual object is decorated with the first virtual element, a decoration time progress bar may further be displayed. For example, as shown in FIG. 14, the aspect shown in FIG. 3 may alternatively be implemented as the following operation 1410 to operation 1450.

Operation 1410: Display a first virtual object and an element decoration area located in a virtual scene. For example, a first virtual object and an element decoration area are output for display in a virtual scene. The element decoration area includes a region with an element decoration function. The element decoration function is configured to provide a decoration for the first virtual object.

The element decoration area includes an element decoration function, and the element decoration function is configured for providing a decoration for the first virtual object.

In an aspect, an element configuration operation for the element decoration area is received. The element configuration operation is configured for adjusting a virtual element corresponding to the element decoration function to be the first virtual element.

For example, the virtual element corresponding to the element decoration function is configured for applying the virtual element to a virtual object. By performing the element configuration operation on the element decoration area, a virtual element applied in an element application process can be determined.

In some aspects, a trigger operation for an element configuration control in the element decoration area is received, and an element display interface is displayed. For example, in addition to the element decoration function and an element preview function, the element decoration area further has an element configuration function. The element configuration function is configured for configuring a virtual element used in an element decoration process.

In some aspects, different functions are implemented using different function areas. For example, the element configuration function is implemented using a function area represented by the element configuration control. For example, the element decoration area includes an element configuration control, and the element configuration control is configured to trigger a configuration operation on a virtual element provided in the element decoration area. The element display interface is displayed based on at least one of a plurality of trigger operations such as a clicking operation, a long press operation, and a double-click operation performed on the element configuration control. The element display interface includes a plurality of accessory elements, and at least one accessory element is combined to obtain the virtual element corresponding to the element decoration function.

In some aspects, the virtual element may be implemented as a single accessory element, or may be implemented as an element formed by a combination of the plurality of accessory elements. The accessory element is a smallest element unit configured to be applied to a virtual object. For example, the accessory element is implemented as at least one of a plurality of elements such as a virtual costume, a virtual item, and a virtual prop. The virtual costume is, for example, a virtual upper garment, virtual trousers, a virtual hat, or virtual shoes. The virtual item is, for example, virtual glasses, virtual earrings, or a virtual necklace. The virtual prop is, for example, a virtual backpack, a virtual slingshot, or a virtual medicine bottle.

In some aspects, an element selection operation on the at least one accessory element of the plurality of accessory elements is received as the element configuration operation. For example, the element selection operation is an operation of selecting from a plurality of accessory elements, and at least one accessory element is determined from the plurality of accessory elements according to the element selection operation. For example, the plurality of accessory elements include a virtual upper garment C1, a virtual upper garment C2, virtual trousers T1, a virtual hat M1, a virtual hat M2, virtual shoes S1, virtual earrings E1, a virtual necklace N1, and a virtual backpack B1. An element selection operation on the virtual upper garment C1, the virtual trousers T1, and the virtual necklace N1 is received, and the at least one accessory element is determined to include the virtual upper garment C1, the virtual trousers T1, and the virtual necklace N1.

In some aspects, the at least one accessory element is configured to be combined to obtain the virtual element corresponding to the element decoration function. For example, a virtual element 1 is formed using the virtual upper garment C1, the virtual trousers T1, and the virtual necklace N1. In addition, the virtual jacket C2, the virtual trousers T1, and the virtual necklace N1 may further be used to form a virtual element 2, and the like. This is not limited herein.

In an aspect, the first virtual element is displayed in the element decoration area in response to the element configuration operation. For example, after the element configuration operation, the virtual element configured based on the element configuration operation may be displayed in the element decoration area. For example, the virtual upper garment C1, the virtual trousers T1, and the virtual necklace N1 are determined based on the element configuration operation, so that the virtual element 1 obtained by combining the virtual upper garment C1, the virtual trousers T1, and the virtual necklace N1 is displayed in the element decoration area. Alternatively, the virtual upper garment C1 is determined based on the element configuration operation, so that the virtual upper garment C1 is displayed in the element decoration area as the virtual element 2.

In some aspects, when a preview sub-area and a decoration sub-area exist in the element decoration area, a virtual element configured based on the element configuration operation, that is, the first virtual element, may be displayed in the preview sub-area of the element decoration area.

In the foregoing aspect, a solution of adjusting a virtual element based on an element configuration operation, so as to display the adjusted virtual element in an element decoration area is described. The player is allowed to select different virtual elements from a plurality of accessory elements and combine the different virtual elements into each other, thereby enriching content diversity of a virtual decoration. In addition, a virtual element obtained based on the element configuration operation is displayed in real time in an element decoration area, so that the player not only can instantly see a decoration effect, but also can make further adjustment and optimization according to a feedback of the effect, thereby helping improve efficiency of decorating a virtual object by the player.

In an aspect, when a plurality of decoration areas exist in the element decoration area, an element configuration operation on at least one of the plurality of decoration areas is received, and virtual elements corresponding to the plurality of decoration areas, respectively, are determined. For example, a plurality of decoration areas each correspond to an element configuration control, and a virtual element corresponding to the decoration area is configured based on a trigger operation on the element configuration control. For example, three decoration areas exist in the element decoration area, and the three decoration areas each correspond to an element configuration control. Based on a trigger operation on an element configuration control corresponding to a decoration area 1, a virtual element corresponding to the decoration area 1 is configured. For example, a virtual element A is configured as including an accessory element a1 and an accessory element a2. Similarly, a virtual element corresponding to a decoration area 2 may alternatively be configured based on a trigger operation on the element configuration control corresponding to the decoration area 2. For example, a virtual element B is configured as including an accessory element b1.

Operation 1420: Receive an object control operation for the first virtual object. For example, an object control operation performed on an object control element associated with the first virtual object is received. The object control element is configured to cause the first virtual object to interact with the element decoration area in the virtual scene.

The object control operation is configured for controlling the first virtual object to interact with the element decoration area in the virtual scene.

For example, when the element decoration area is implemented as a virtual decoration wall, the first moving operation for the first virtual object to pass through the virtual decoration wall is received as the object control operation. Alternatively, when the element decoration area is implemented as a decoration scene zone, the second moving operation for moving the first virtual object into the decoration scene zone is received as the object control operation.

In an aspect, the virtual scene includes a plurality of element decoration areas. The plurality of element decoration areas correspond to at least one virtual element, respectively. For example, when the virtual scene is displayed, a plurality of element decoration areas are displayed, and each element decoration area corresponds to at least one virtual element.

In some aspects, each element decoration area corresponds to one virtual element. For example, the virtual scene includes an element decoration area 1 and an element decoration area 2. The element decoration area 1 corresponds to a virtual element A, that is, the element decoration area 1 is configured to decorate a virtual object with the virtual element A. The element decoration area 2 corresponds to a virtual element B, that is, the element decoration area 2 is configured to decorate a virtual object with the virtual element B.

In some aspects, each element decoration area corresponds to a plurality of virtual elements. For example, the virtual scene includes an element decoration area 1 and an element decoration area 2. The element decoration area 1 corresponds to a virtual element A and a virtual element B. That is, the element decoration area 1 may be configured to decorate a virtual object with the virtual element A, or may be configured to decorate a virtual object with the virtual element B. The foregoing element decoration area includes a decoration area 11 corresponding to the virtual element A and a decoration area 12 corresponding to the virtual element B. The element decoration area 2 corresponds to a virtual element C and a virtual element D. That is, the element decoration area 2 may be configured to decorate a virtual object with the virtual element C, or may be configured to decorate a virtual object with the virtual element D, or the like.

In some aspects, a first object control operation for the first virtual object is received. The first object control operation is configured for controlling the first virtual object to interact with a first element decoration area in the virtual scene, and the first element decoration area is configured to decorate the first virtual object with the first virtual element. For example, an example in which the element decoration area is implemented as a virtual decoration wall is used. The virtual scene includes a virtual decoration wall Q1 and a virtual decoration wall Q2. If the first element decoration area is the virtual decoration wall Q1, the player controls the first virtual object to interact with the virtual decoration wall Q1 in the virtual scene, for example, to pass through the virtual decoration wall Q1, that is, the first object control operation for the first virtual object is received. The first object control operation is configured for decorating the first virtual element corresponding to the first element decoration area on the first virtual object. For example, an example in which the element decoration area is implemented as a decoration scene zone is used. The virtual scene includes a decoration scene zone P1 and a decoration scene zone P2. If the first element decoration area is the decoration scene zone P1, the player controls the first virtual object to interact with the decoration scene zone P1 in the virtual scene, for example, to move to the decoration scene zone P1, that is, the first object control operation for the first virtual object is received. The first object control operation is configured for decorating the first virtual element corresponding to the first element decoration area on the first virtual object.

In some aspects, a second object control operation for the first virtual object is received.

The second object control operation is configured for controlling the first virtual object to interact with a second element decoration area in the virtual scene, the second element decoration area is configured to decorate the first virtual object with a second virtual element, and the first virtual element and the second virtual element are different. For example, an example in which the element decoration area is implemented as a virtual decoration wall is used. The virtual scene includes a virtual decoration wall Q1 and a virtual decoration wall Q2. If the second element decoration area is the virtual decoration wall Q2, the player controls the first virtual object to interact with the virtual decoration wall Q2 in the virtual scene, for example, to pass through the virtual decoration wall Q2, that is, the second object control operation for the first virtual object is received. The second object control operation is configured for decorating the second virtual element corresponding to the second element decoration area on the first virtual object. For example, an example in which the element decoration area is implemented as a decoration scene zone is used. The virtual scene includes a decoration scene zone P1 and a decoration scene zone P2. If the second element decoration area is the decoration scene zone P2, the player controls the first virtual object to interact with the decoration scene zone P2 in the virtual scene, for example, to move to the decoration scene zone P2, that is, the second object control operation for the first virtual object is received. The second object control operation is configured for decorating the second virtual element corresponding to the second element decoration area on the first virtual object.

In the foregoing aspect, the virtual scene has a plurality of element decoration areas, and different element decoration areas can be configured to decorate different virtual elements. The plurality of element decoration areas is introduced to provide diversified decoration selection for the player. The player controls the virtual object to interact with the plurality of element decoration areas in the virtual scene to preview effects of the virtual object decorated with a plurality of elements. Operations required in a switching process of the virtual object to switch a plurality of decoration effects are relatively simple, and a complex saving and loading process is not required, so that the player can quickly determine a required decoration element from a plurality of decoration elements, thereby improving efficiency of decorating the virtual object by the player.

Operation 1430: Display, based on the object control operation, the first virtual object decorated with the first virtual element. For example, based on the object control operation performed on the object control element, the first virtual object decorated with a first virtual element is output for display. The first virtual element includes a virtual decoration element determined based on the object control operation causing interaction of the first virtual object with the element decoration area.

In some aspects, the first virtual object decorated with the first virtual element is displayed in response to the object control operation. The first virtual element is a virtual element determined based on the object control operation and the element decoration area. For example, when the object control operation instructs the first virtual element, the first virtual element is decorated on the first virtual object, to display the first virtual object decorated with the first virtual element.

In an aspect, the first virtual object is decorated with a third virtual element. For example, the third virtual element is a virtual element decorated on the first virtual object before decorating with the first virtual element.

In some aspects, in response to the object control operation, an element decoration action of decorating with the first virtual element performed by the first virtual object is displayed. In some aspects, an element switching animation is displayed in response to the object control operation. The element switching animation includes that the first virtual object performs an element switching action of switching the third virtual element to the first virtual element.

In some aspects, when at least one different accessory element exists between the third virtual element and the first virtual element, an element switching action of switching the different accessory element to the first virtual element is displayed in response to the object control operation. For example, the third virtual element includes an accessory element a1 and an accessory element b1, and the first virtual element includes an accessory element a1 and an accessory element b2. After the object control operation, an element switching action of switching the accessory element b1 to the accessory element b2 by the first virtual object is displayed, so as to display the element switching animation. Alternatively, the third virtual element includes an accessory element a1 and an accessory element b1, and the first virtual element includes an accessory element a2 and an accessory element b2. After the object control operation, an element switching action of switching the accessory element a1 and the accessory element b1 to the accessory element a2 and the accessory element b2 by the first virtual object is displayed, so as to display the element switching animation and the like.

In some aspects, when the third virtual element is the same as the first virtual element, the element switching animation is not displayed. For example, when at least one accessory element forming the third virtual element is the same as at least one accessory element forming the first virtual element, it is considered that the third virtual element is the same as the first virtual element. For example, if the third virtual element includes an accessory element a1 and an accessory element b1, and the first virtual element also includes an accessory element a1 and an accessory element b1, the first virtual object is decorated with the first virtual element, so that the first virtual element does not need to be decorated on the first virtual object, that is, the element switching animation in which the first virtual object performs an element switching action is not displayed. In the foregoing aspect, by presenting the element switching action, the player can intuitively see a process in which the first virtual object changes from being decorated with the third virtual element to being decorated with the first virtual element. When different accessory elements exist between the third virtual element and the first virtual element, only an element switching action corresponding to a different configuration element is displayed, thereby avoiding an unnecessary visual rendering operation, saving rendering resources, and improving an operation response speed and decoration efficiency.

In an aspect, in response to the object control operation, an element decoration action of decorating with the first virtual element performed by the first virtual object is displayed. In some aspects, an element decoration animation is displayed in response to the object control operation. The element decoration animation includes that the first virtual object performs an element decoration action of decorating with the first virtual element. For example, the first virtual object is not decorated with another virtual element. After the object control operation, the first virtual object performs, in the virtual scene, an element decoration action of decorating with the first virtual element, and uses an animation displaying the element decoration action as the element decoration animation.

In the foregoing aspect, the first virtual object can be automatically decorated with the first virtual element by presenting the element decoration action, thereby avoiding an operation that a player manually decorates the first virtual object with the first virtual element, and improving efficiency of human-computer interaction.

In an aspect, when the object control operation represents the first virtual object moving from a first side to a second side of the element decoration area, the first virtual object decorated with the first virtual element is displayed. In some aspects, in response to that the object control operation represents the first virtual object moving from the first side to the second side of the element decoration area, the first virtual object decorated with the first virtual element is displayed. The first side is different from the second side. For example, the element decoration area is implemented as a virtual decoration wall. The virtual decoration wall correspondingly has the first side and the second side, and the first side and the second side are separated from each other by the virtual decoration wall. When the object control operation represents that the player controls the first virtual object to move from the first side to the second side of the element decoration area, this is considered as a process of decorating the first virtual element on the first virtual object, that is, the first virtual object decorated with the first virtual element is displayed.

In some aspects, the first side and the second side can be preset directions. For example, the left side of the virtual decoration wall is considered as the first side, and the right side of the virtual decoration wall is considered as the second side. Alternatively, the left side of the virtual decoration wall is considered as the second side, and the right side of the virtual decoration wall is considered as the first side. For example, the element decoration area may alternatively be implemented as a decoration scene zone, and the first side and the second side corresponding to the decoration scene zone may be determined based on any area boundary in the decoration scene zone. This is not limited herein.

In an aspect, when a condition that the object control operation represents the first virtual object moving from the second side to the first side of the element decoration area is received, displaying of the first virtual object undecorated with the first virtual element is resumed. In some aspects, when the first virtual object is decorated with the first virtual element and continues to receive the object control operation, in response to that the object control operation represents the first virtual object moving from the second side to the first side of the element decoration area, displaying of the first virtual object undecorated with the first virtual element is resumed. For example, after the first virtual object is decorated with the first virtual element using the object control operation, if the object control operation is received again to instruct the first virtual object to move from the second side to the first side of the virtual decoration wall, the first virtual element is removed from the first virtual object, to resume displaying of the first virtual object undecorated with the first virtual element.

In the foregoing aspect, when the player controls the virtual object to move from one side of the element decoration area to the other side, an effect after decoration is immediately responded to and displayed, thereby significantly improving efficiency of decorating the virtual object with the virtual element, and improving efficiency of human-computer interaction. In addition, the player is allowed to cancel a decoration by simply moving in a reverse direction, thereby avoiding a complex operation of redecoration, and further improving efficiency of human-computer interaction.

In an aspect, the first virtual object may interact with the element decoration area in a plurality of interaction forms. The interaction form is configured for indicating an interaction situation between the first virtual object and the element decoration area. The plurality of interaction forms include a jumping interaction form, a moving interaction form, a designated posture interaction form, a creeping interaction form, and the like. This is not limited herein. In some aspects, the plurality of interaction forms include a first interaction form. In response to that the object control operation represents the first virtual object interacting with the element decoration area in the first interaction form, the first virtual object decorated with a first accessory element is displayed. The first interaction form is configured for decorating the first accessory element in the first virtual element on the first virtual object. The first interaction form belongs to the plurality of interaction forms. In some aspects, different interaction forms correspond to at least one accessory element in the first virtual element, to represent that the corresponding at least one accessory element is decorated on the first virtual object. For example, the first interaction form is implemented as a jumping interaction form. If the jumping interaction form is configured for decorating a virtual hat in the virtual element on the first virtual object, the virtual hat is used as the first accessory element corresponding to the jumping interaction form. If the object control operation represents the first virtual object interacting with the element decoration area in the jumping interaction form, the first virtual object decorated with the virtual hat is displayed.

In some aspects, the plurality of interaction forms further include a second interaction form, and the second interaction form is different from the first interaction form. In response to that the object control operation represents the first virtual object interacting with the element decoration area in the second interaction form, the first virtual object decorated with a second accessory element is displayed. The second interaction form is configured for decorating the second accessory element in the first virtual element on the first virtual object. For example, the first accessory element is different from the second accessory element. For example, the second interaction form is implemented as a creeping interaction form. If the creeping interaction form is configured for decorating virtual shoes in the virtual element on the first virtual object, the virtual shoes are used as the second accessory element corresponding to the creeping interaction form. If the object control operation represents the first virtual object interacting with the element decoration area in the creeping interaction form, the first virtual object decorated with the virtual shoes is displayed.

In the foregoing aspect, the player can use different accessory elements for decoration by interacting with the element decoration area in different interaction forms, thereby improving pertinence and diversity of virtual element decoration. According to another aspect, an operational error may alternatively be reduced by displaying an interaction form during an element decoration, thereby avoiding resource waste caused by an unrestricted decoration operation performed by the player.

Operation 1440: Display a decoration time progress bar. For example, a decoration time indicator, indicating a relationship between a decoration duration and a preset decoration duration is output for display. The preset decoration duration limits a time period during which the first virtual element is decorated on the first virtual object.

The decoration time progress bar is configured to represent a relationship between a decoration duration and a preset decoration duration, and the decoration duration is configured for representing a duration for which the first virtual object is decorated with the first virtual element. For example, the preset decoration duration is a duration restriction that is set in advance, and is configured for limiting a duration for which the first virtual element is decorated on the first virtual object. That is, the decoration time progress bar is configured to indicate countdown of previewing the first virtual element on the first virtual object.

For example, a type of the decoration time progress bar includes at least one of a linear time progress bar (a straight line is configured to represent a preset decoration duration, and the decoration duration is displayed by filling or changing a color), a circular/annular time progress bar (a circle/annulus is configured to represent a preset decoration duration, and the decoration duration is displayed by filling or changing a color), a percentage number time progress bar (a percentage number is configured for representing a ratio of a decoration duration to a preset decoration duration), and the like. This is not limited herein.

In some aspects, the preset decoration duration is a fixed value, such as one minute or three minutes. In some aspects, the preset decoration duration is a value determined according to a virtual element. For example, different virtual elements each correspond to a preset decoration duration. For example, a preset decoration duration corresponding to a virtual element A is two minutes, a preset decoration duration corresponding to a virtual element B is three minutes, and a preset decoration duration corresponding to a virtual element C is two minutes. In some aspects, the preset decoration duration is a value determined according to an object level of the first virtual object. For example, if the object level of the first virtual object is higher, the preset decoration duration is longer, and if the object level of the first virtual object is lower, the preset decoration duration is shorter.

In some aspects, when the first virtual element is a virtual element redeemed by the player, after the first virtual object is decorated with the first virtual element, the decoration time progress bar may not be displayed. When the first virtual element is a virtual element that is not redeemed by the player, after the first virtual object is decorated with the first virtual element, a preset decoration duration corresponding to the first virtual element is determined, and the decoration time progress bar is displayed. For example, the first virtual element is a virtual element that the player intends to try on by the first virtual object. After the first virtual object decorated with the first virtual element is displayed based on the object control operation, a preset decoration duration corresponding to the first virtual element is determined, and a decoration time progress bar is displayed based on the preset decoration duration and the decoration duration for which the first virtual object is decorated with the first virtual element.

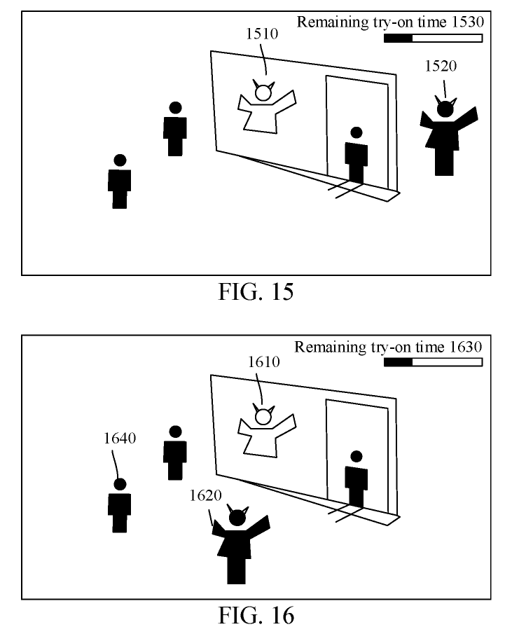

FIG. 15 is a schematic diagram of an interface displaying a decoration time progress bar. The first virtual object 1520 trying on the first virtual element 1510 is displayed, and a remaining try-on time 1530 is configured for representing the decoration time progress bar. The length of the decoration time progress bar is a preset decoration duration. A white area represents a decoration duration for which the first virtual object 1520 is decorated with the first virtual element. A black area represents a difference between the preset decoration duration and the decoration duration, that is, represents a remaining duration for which the first virtual object can still be decorated with the first virtual element.

In some aspects, an interaction animation in which the first virtual object decorated with the first virtual element performs object interaction with another virtual object in a virtual scene is displayed. For example, the object interaction is implemented in a plurality of interaction forms such as hailing, clapping, and dialoguing. For example, after being decorated with the first virtual element, the first virtual object moves to another virtual object, and an animation generated in the moving process is considered as an interaction animation or the like. FIG. 16 is a schematic diagram of an interface for performing object interaction with another virtual object. The first virtual object 1620 decorated with the first virtual element 1610 is displayed, and a remaining try-on time 1630 is configured for representing the foregoing decoration time progress bar. Compared with the foregoing shown in FIG. 15, the first virtual object moves to another virtual object (for example, a virtual object 1640), the moving process is considered as an object interaction form, and an animation generated in the moving process is considered as an interaction animation.

In an aspect, an element scoring result of another virtual object for the first virtual element is displayed. For example, after the first virtual object decorated with the first virtual element is displayed, a scoring interface may be displayed on a terminal screen corresponding to another virtual object, respectively, and the scoring interface is configured to instruct to score a decoration effect of the first virtual element decorated on the first virtual object. In some aspects, a player controlling another virtual object may perform a scoring process on the scoring interface, so as to display an element scoring result on a terminal screen corresponding to the first virtual object. The element scoring result is a result obtained after a decoration effect of the first virtual element being applied to the first virtual object is scored. In some aspects, the element scoring result includes scoring results corresponding to other virtual objects, respectively. For example, the element scoring result includes scoring results published by a virtual object K1 and a virtual object K2, respectively. A scoring result of the virtual object K1 is 8.5, and a scoring result of the virtual object K2 is 7. In some aspects, the element scoring result is a result obtained by combining scoring results corresponding to other virtual objects, respectively. For example, if the element scoring result is 8, the scoring result is obtained by averaging scoring results published by the virtual object K1, the virtual object K2, and a virtual object K3, respectively.

Operation 1450: Display, when the decoration duration corresponding to the first virtual object reaches the preset decoration duration, the first virtual object not decorated with the first virtual element. For example, based on the decoration duration reaching the preset decoration duration, the first virtual object without the first virtual element is output for display.

In some aspects, in response to that the decoration duration corresponding to the first virtual object reaches the preset decoration duration, the first virtual object undecorated with the first virtual element is displayed. For example, after the decoration duration for which the first virtual object is decorated with the first virtual element reaches the preset decoration duration, an application situation of the first virtual element being applied to the first virtual object is canceled, so as to display the first virtual object undecorated with the first virtual element.

In some aspects, if the first virtual object is not decorated with another virtual element before being decorated with the first virtual element, when the first virtual object undecorated with the first virtual element is displayed, displaying of the first virtual object undecorated with the another virtual element is resumed.

In some aspects, if the first virtual object is decorated with the third virtual element before being decorated with the first virtual element, when the first virtual object undecorated with the first virtual element is displayed, displaying of the first virtual object decorated with the third virtual element is resumed.

The foregoing content is described using an example in which the element decoration area is implemented as a virtual decoration wall.

In an aspect, if the element decoration area is implemented as a decoration scene zone, when the first virtual object moves into a decoration scene zone corresponding to the first virtual element, the first virtual object decorated with the first virtual element is displayed. When the first virtual object moves out of the decoration scene zone corresponding to the first virtual element, displaying of the first virtual object is resumed.

In an aspect, when the first virtual object moves into a decoration scene zone corresponding to the first virtual element, the first virtual object decorated with the first virtual element and a decoration time progress bar are displayed. In response to that the decoration duration corresponding to the first virtual object reaches the preset decoration duration, prompt information is displayed. The prompt information is configured for prompting the first virtual object to leave the decoration scene zone. Alternatively, in response to that the decoration duration corresponding to the first virtual object reaches the preset decoration duration, an object moving-out animation of automatically moving the first virtual object out of the decoration scene zone is displayed.

In the aspects of this disclosure, content of displaying a decoration time progress bar is described. In a case that the first virtual object is decorated with the first virtual element that is not redeemed, the player can be prompted, using the decoration time progress bar, of a relationship between the decoration duration and the preset decoration duration, so as to not only remind the player that the first virtual element has a decoration time limitation, but also encourage the player to redeem the first virtual element. In addition, the player can further present, to another player within the preset decoration duration, the first virtual object decorated with the first virtual element, thereby enhancing interaction between the first virtual object and another virtual object controlled by the another player, and improving player interaction enthusiasm. The another player can further be indirectly encouraged to redeem the first virtual element, thereby improving efficiency of human-computer interaction.

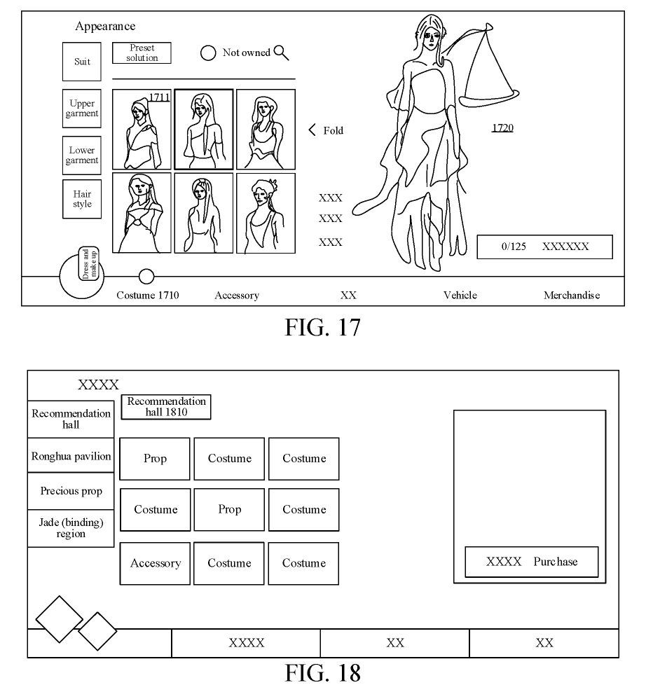

In an aspect, setting of a virtual costume exists in related art, that is, a player may decorate a virtual object of the player in a manner such as redeeming a costume, so that the virtual object is more personalized. To make the player have a desire to redeem the virtual costume, the virtual costume mostly have a preview effect, and previews are mostly placed in an independent costume presentation and replacement model. FIG. 17 is a schematic diagram of an interface in related art. Content subordinate to a costume 1710 is shown, and includes a plurality of virtual costumes such as a virtual costume 1711. Based on selection of the virtual costume 1711, a preview effect corresponding to the virtual costume may be displayed at a preview area 1720. That is, in the foregoing preview process, the player needs to enter the costume presentation and replacement model to find a corresponding virtual costume and then preview the corresponding virtual costume. The preview process can only be seen by the player, but cannot be seen by other players. Therefore, exposure of a new virtual costume is very limited. Except the player who has purchased and worn the virtual costume, other players cannot see, in a virtual scene in another manner, an effect that others wear the virtual costume. In addition, operations of entering a preview model are very complex, and the player exits the preview process when exiting the model. FIG. 18 is a schematic diagram of another interface in related art. A recommendation hall 1810 includes content such as costumes, accessories, and props. A redeeming process may be performed based on selection of a virtual costume. However, the virtual costume cannot be applied to a virtual object controlled by a player, that is, the player cannot perform a wearing preview, and lacks a desire to redeem the virtual costume. Based on this, this disclosure provides the foregoing virtual element decoration method. In an aspect, the virtual element may be implemented as a virtual costume, and the foregoing virtual element decoration method may be referred to as a convenient manner of previewing costume applied in the open world. The following describes the virtual element decoration method from two aspects: an interface side and a technical side.

### Interface side

For example, one element decoration model is set in a virtual scene. The element decoration model corresponds to two areas. One area is configured to present a virtual element (for example, the preview sub-area), and the other area is a try-on area configured to decorate with a virtual element (for example, the decoration sub-area). As shown in FIG. 7, a hot virtual costume is displayed in the preview sub-area 711 as the first virtual element 720. The hot virtual costume displayed in the preview sub-area can be quickly applied to decoration using the decoration sub-area 712.

For example, the try-on area is a costume try-on determining medium. When the first virtual object is controlled to pass through the try-on area, the determining medium is triggered, to replace the current costume on the first virtual object with the currently presented virtual costume.

As shown in FIG. 10, at the current moment, if the first virtual object 1030 passes through the decoration sub-area 1020, the determining medium is triggered, to replace the current costume on the first virtual object 1030 with the virtual element 1000 currently presented in the preview sub-area 1010. For example, a duration (a preset decoration duration) exists when the costume is tried on, and the virtual costume decorated disappears after the duration ends. As shown in FIG. 15, the first virtual object 1520 is decorated with the first virtual element 1510 at the current moment, and the remaining try-on time 1530 is further displayed on an interface, to prompt a player of an effective duration of decorating with the first virtual element.

For example, the first virtual element decorated on the first virtual object can be seen by another player within a try-on time. In addition, a plurality of players are allowed to control corresponding virtual objects to enter the try-on area simultaneously to trigger a try-on effect, so that a group presentation and promotion effect is achieved. In addition, after the countdown ends, the first virtual object resumes an original costume style.

### Technical side

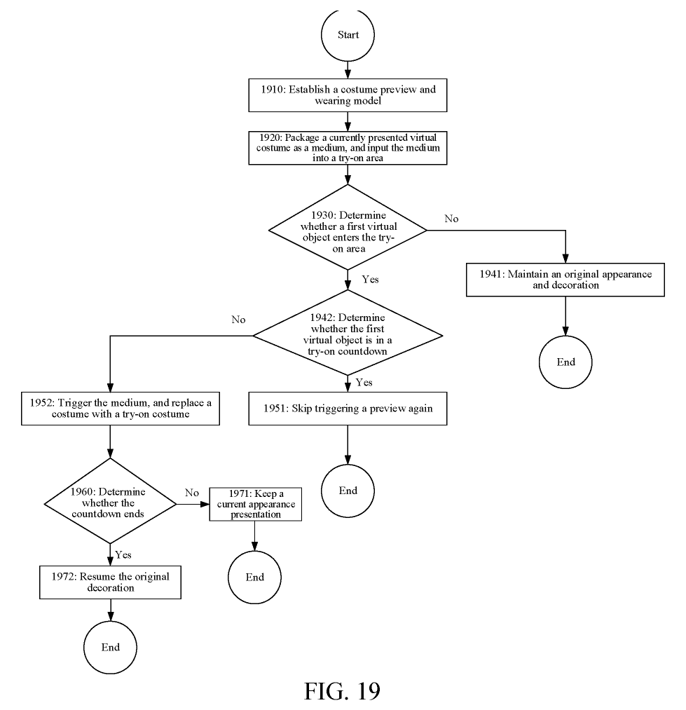

For example, FIG. 19 is a technical flowchart of performing a virtual element decoration method by a costume preview and wearing model (that is, the foregoing costume presentation and replacement model).

### Operation 1910: Establish a costume preview and wearing model.

For example, a costume preview and wearing model with an interaction area is set in a virtual scene, and the model is mainly divided into two parts, which are a presentation area (a preview sub-area) and a try-on area (a decoration sub-area), respectively.

The display area is an area that can carry an image, and is configured to display a costume presentation image on a terminal. The presentation image may be transmitted to the terminal using the server for presentation, and the presentation image may be replaced.

The try-on area is an area with a logic determining mechanism, and a determining process is implemented by identifying whether a virtual object exists.

### Operation 1920: Package a currently presented virtual costume as a medium, and input the medium into the try-on area.

For example, after determining the presentation image corresponding to the virtual costume needing to be presented, the server may further package the virtual costume, and input the costume into the try-on area, so that the virtual object may perform a try-on process on the virtual costume using the try-on area.

### Operation 1930: Determine whether a first virtual object enters the try-on area.

For example, if no virtual object passes through the trying-on area, the area keeps displaying in a prompting state (for example, to prompt that the first virtual element may be tried on by passing through the area), and a costume replacement effect is not triggered. If a virtual object passes through the area, secondary determining is performed. For example, when it is determined that the first virtual object does not enter the try-on area, the following operation 1941 is performed. When it is determined that the first virtual object enters the try-on area, the following operation 1942 is performed.

### Operation 1941: Maintain an original appearance and decoration.

For example, if the first virtual object does not enter the try-on area, an appearance of the first virtual object remains unchanged.

### Operation 1942: Determine whether the first virtual object is in a try-on countdown.

For example, if the first virtual object enters the try-on area, an appearance change of the first virtual object is adjusted.

In some aspects, if the current virtual object is in a trying-on state (that is, the current virtual object has passed through the area and activated to trigger a wearing preview effect, and the server has transmitted corresponding costume data to the terminal and completed replacement of an external costume), a try-on mechanism is not triggered again. In some aspects, if the costume worn by the current virtual object is a costume that is purchased and currently previewed, the server determines whether the costume worn by the player is the same as the costume currently previewed. If yes, a preview replacement effect is not triggered, and the costume style currently purchased and worn by the player is maintained. In some aspects, if the player does not currently wear the previewed costume style, a corresponding try-on mechanism is triggered, the server transmits related costume data to the terminal, and the terminal compares the costume data with the costume worn by the player, to replace the costume at a corresponding part with a style currently previewed. If the player wears some accessory elements of the current try-on costume, for example, the entire costume includes a plurality of parts such as a hat, a costume, shoes, trousers, and gloves, and the player currently wears only a purchased hat, each part of the costume currently worn by the player is identified for determining. If a purchased try-on costume exists, the part is not replaced, and only a part different from the part of the costume currently previewed is replaced.

In some aspects, if the player wears a part not included in the costume, for example, the costume does not include a part of an accessory, synchronous replacement is not performed, and only a part included in the costume is replaced. That is, if the try-on mechanism is triggered and at least one accessory area in the current try-on costume is tried on, whether the player is in the try-on countdown is further determined. For example, when it is determined that the player is in the try-on countdown, the following operation 1951 is performed. When it is determined that the player is in the try-on countdown, the following operation 1952 is performed.

### Operation 1951: Skip triggering the preview again.

For example, if the player has performed try-on, the preview is not triggered again.

### Operation 1952: Trigger the medium, and replace a costume with the try-on costume.

For example, if the player has not performed try-on, an accessory element that does not belong to the current try-on costume is replaced.

### Operation 1960: Determine whether the countdown ends.

In some aspects, the terminal determines, in real time, whether the countdown ends. Alternatively, the server transmits corresponding countdown data to the terminal, and the terminal displays a countdown control that is visible to the player. The control presents a time validity of currently wearing the previewed suit, and determines, according to the current remaining time, whether to maintain the preview of the costume. For example, when it is determined that the countdown does not end, the following operation 1971 is performed. When it is determined that the countdown ends, the following operation 1972 is performed.

### Operation 1971: Maintain a current appearance presentation.

For example, when it is determined that the countdown does not end, the first virtual object decorated with the current try-on costume continues to be displayed.

That is, when a countdown time is greater than 0 second, the preview presentation of the current costume is maintained.

### Operation 1972: Resume the original decoration.

For example, when it is determined that the countdown ends, displaying of the first virtual object before being decorated with the try-on costume is resumed.

That is, when the countdown time is less than or equal to 0 second, the preview of the current costume is released, and the terminal determines a costume style that needs to be resumed on the first virtual object and transmits the costume style to the server. The server returns original costume wearing data of the first virtual object to replace a corresponding part. After replacement, the player returns to the costume style before the preview.

In the aspects of this disclosure, effects that a game costume preview approach in related art is relatively complex and external presentation cannot trigger sharing can be effectively overcome. By quick interaction between the first virtual object and the element decoration area, the first virtual object can quickly preview an appearance of a costume, and can further generate a group presentation effect through a process of presenting the costume to other players. The element decoration area is not merely limited to a virtual decoration wall located at a single location, and may alternatively be implemented as a decoration scene zone having a property of an area range, so that the first virtual object can enter the decoration scene zone to continuously present a costume try-on effect, and leave the area to resume original costume presentation. Efficiency and interestingness of decorating with a costume during a game process are greatly improved, and efficiency of human-computer interaction is improved.

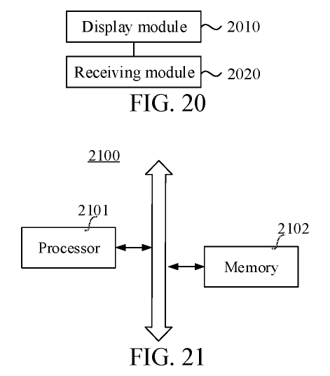

FIG. 20 is a structural block diagram of a virtual element decoration apparatus according to an aspect of this disclosure. As shown in FIG. 20, the apparatus includes the following parts:

a display module 2010, configured to display a first virtual object and an element decoration area located in a virtual scene, the element decoration area including an area providing an element decoration function, and the element decoration function being configured for providing a decoration for the first virtual object; and a receiving module 2020, configured to receive an object control operation for the first virtual object, the object control operation being configured for controlling the first virtual object to interact with the element decoration area in the virtual scene, the display module 2010 being configured to display, in response to the object control operation, the first virtual object decorated with a first virtual element, the first virtual element being a virtual decoration element determined based on the object control operation and the element decoration area.

In an aspect, the element decoration area is a three-dimensional space area in the virtual scene, and the object control operation is configured for controlling the first virtual object to move to interact with the three-dimensional space area in which the element decoration area is located. In an aspect, the element decoration area includes a virtual decoration wall; and the receiving module 2020 is further configured to receive a first moving operation for the first virtual object, the first moving operation being configured for controlling the first virtual object to pass through the virtual decoration wall in the virtual scene. In an aspect, the element decoration area includes a decoration scene zone; and the receiving module 2020 is further configured to receive a second moving operation for the first virtual object, the second moving operation being configured for controlling the first virtual object to move to the decoration scene zone.

In an aspect, the element decoration area includes a preview sub-area and a decoration sub-area, the preview sub-area being configured to preview the first virtual element, and the decoration sub-area being configured to decorate the first virtual object with the first virtual element displayed in the preview sub-area during interaction with the first virtual object.

In an aspect, the element decoration area includes decoration areas corresponding to a plurality of virtual elements, respectively, including the first decoration area configured to decorate with the first virtual element; and the display module 2010 is further configured to display, in response to that the object control operation instructs the first virtual object to interact with the first decoration area in the element decoration area, the first virtual object decorated with the first virtual element.

In an aspect, the display module 2010 is further configured to display a decoration time progress bar, the decoration time progress bar being configured to represent a relationship between a decoration duration and a preset decoration duration; the preset decoration duration being configured for limiting a duration for which the first virtual element is decorated on the first virtual object; and the decoration duration being configured for representing a duration for which the first virtual object is decorated with the first virtual element. In an aspect, the display module 2010 is further configured to display, in response to that the decoration duration corresponding to the first virtual object reaches the preset decoration duration, the first virtual object not decorated with the first virtual element.

In an aspect, the receiving module 2020 is further configured to receive an element configuration operation for the element decoration area, the element configuration operation being configured for adjusting a virtual element corresponding to the element decoration function to be the first virtual element. In an aspect, the receiving module 2020 is further configured to: receive a trigger operation for an element configuration control in the element decoration area; display an element display interface, the element display interface including a plurality of accessory elements, and at least one accessory element being combined to obtain the virtual element corresponding to the element decoration function; and receive an element selection operation on the at least one accessory element of the plurality of accessory elements as the element configuration operation.

In an aspect, the display module 2010 is further configured to: display, in response to that the object control operation represents the first virtual object moving from the first side to the second side of the element decoration area, the first virtual object decorated with the first virtual element, the first side being different from the second side; and resume, in response to that the object control operation represents the first virtual object moving from the second side to the first side of the element decoration area, displaying the first virtual object undecorated with the first virtual element.

In an aspect, the display module 2010 is further configured to display, in response to that the object control operation represents the first virtual object interacting with the element decoration area in a first interaction form, the first virtual object decorated with a first accessory element, the first interaction form being configured for decorating the first accessory element in the first virtual element on the first virtual object; or display, in response to that the object control operation represents the first virtual object interacting with the element decoration area in a second interaction form, the first virtual object decorated with a second accessory element, the second interaction form being configured for decorating the second accessory element in the first virtual element on the first virtual object. The first interaction form is different from the second interaction form, and the first accessory element is different from the second accessory element.

In an aspect, the receiving module 2020 is further configured to receive a first object control operation for the first virtual object, the first object control operation being configured for controlling the first virtual object to interact with a first element decoration area in the virtual scene, and the first element decoration area being configured to decorate the first virtual object with the first virtual element; or receive a second object control operation for the first virtual object, the second object control operation being configured for controlling the first virtual object to interact with a second element decoration area in the virtual scene, the second element decoration area being configured to decorate the first virtual object with a second virtual element, and the first virtual element being different from the second virtual element.

In an aspect, the display module 2010 is further configured to display, in response to the object control operation, an element switching action of switching a third virtual element to the first virtual element performed by the first virtual object, the third virtual element being a virtual element decorated on the first virtual object before the first virtual object is decorated with the first virtual element.

In an aspect, the display module 2010 is further configured to display, in response to the object control operation, an element decoration action of decorating with the first virtual element performed by the first virtual object.

In an aspect, the element decoration function is configured for providing trying on of a virtual decoration element for the first virtual object; a plurality of virtual elements are provided in the element decoration area; and the display module 2010 is further configured to display, in response to the object control operation, the first virtual object decorated with the first virtual element in a try-on mode, the try-on mode referring to a mode in which the first virtual object is temporarily decorated with the first virtual element.

The virtual element decoration apparatus provided in the foregoing aspect is illustrated only with an example of division of the foregoing function modules. In practical applications, the foregoing functions may be allocated to and completed by different function modules based on requirements. That is, an internal structure of the apparatus is divided into different function modules to complete all or some of the functions described above. In addition, the virtual element decoration apparatus and virtual element decoration method aspects provided in the foregoing aspects belong to the same conception. For the specific implementation process, reference can be made to the method aspects. Details are not described herein again.

FIG. 21 is a structural block diagram of an electronic device 2100 according to an aspect of this disclosure. The electronic device 2100 may be a portable mobile terminal, such as a smartphone, an in-vehicle terminal, a tablet computer, a moving picture experts group audio layer III (MP3) player, a moving picture experts group audio layer IV (MP4) player, a notebook computer, or a desktop computer. The electronic device 2100 may alternatively be referred to as another name such as user device, a portable terminal, a laptop terminal, or a desktop terminal. The electronic device 2100 includes a processor 2101 (an example of processing circuitry) and a memory 2102 (an example of a non-transitory computer-readable storage medium). The processor 2101 may include one or more processing cores, for example, a 4-core processor or an 8-core processor. The processor 2101 may be implemented in at least one hardware form of a digital signal processing (DSP), a field-programmable gate array (FPGA), and a programmable logic array (PLA). The processor 2101 may alternatively include a main processor and a coprocessor. The main processor is a processor configured to process data in an awake state, and is also referred to as a central processing unit (CPU). The coprocessor is a low power consumption processor configured to process the data in a standby state. In some aspects, the processor 2101 may have a graphics processing unit (GPU) integrated therein. The GPU is configured to render and draw content that needs to be displayed on a display screen. In some aspects, the processor 2101 may further include an artificial intelligence (AI) processor. The AI processor is configured to process computing operations related to machine learning. The memory 2102 may include one or more computer-readable storage media. The computer-readable storage medium may be non-transient. The memory 2102 may further include a high-speed random access memory (RAM) and a nonvolatile memory, for example, one or more disk storage devices or flash storage devices. In some aspects, the non-transient computer-readable storage medium in the memory 2102 is configured to store at least one instruction. The at least one instruction is configured for being executed by the processor 2101 to implement the virtual element decoration method provided in the method aspects of this disclosure. In some aspects, the electronic device 2100 further includes one or more sensors. The one or more sensors include, but are not limited to, a proximity sensor, a gyroscope sensor, and a pressure sensor. In some aspects, the electronic device 2100 further includes other component parts. It is noted that the structure shown in FIG. 21 constitutes no limitation on the electronic device 2100, and the electronic device 2100 may include more or fewer components than those shown in the figure, or a combination of some components, or have a different arrangement of components.

In an aspect of this disclosure, a computer device is further provided. The computer device may be implemented as the terminal or the server shown in FIG. 2. The computer device includes a processor and a memory, the memory having at least one instruction, at least one program, a code set, or an instruction set stored therein, the at least one instruction, the at least one program, the code set, or the instruction set being loaded and executed by the processor to implement the virtual element decoration method according to the foregoing method aspects. In an aspect of this disclosure, a computer-readable storage medium, such as a non-transitory computer-readable storage medium, is further provided, having at least one instruction, at least one program, a code set, or an instruction set stored therein, the at least one instruction, the at least one program, the code set, or the instruction set being loaded and executed by a processor to implement the virtual element decoration method according to the foregoing method aspects. In an aspect of this disclosure, a computer program product or a computer program is further provided, including computer instructions, the computer instructions being stored in the computer-readable storage medium. A processor of a computer device reads the computer instructions from the computer-readable storage medium and executes the computer instructions, to cause the computer device to perform the virtual element decoration method according to any one of the foregoing aspects. In some aspects, the computer-readable storage medium may include: a read only memory (ROM), a RAM, a solid state drive (SSD), an optical disc, or the like. The RAM may include a resistance random access memory (ReRAM) and a dynamic random access memory (DRAM). The sequence numbers of the foregoing aspects of this disclosure are merely for description purpose but do not imply the preference among the aspects.

It is noted that all or some of the operations of the foregoing aspects may be implemented by hardware, or may be implemented by a program instructing relevant hardware. The program may be stored in the computer-readable storage medium. The above-mentioned storage medium may be a ROM, a magnetic disk, an optical disc, or the like. The foregoing descriptions are merely example aspects of this disclosure, and are not intended to limit this disclosure. Any modification, equivalent replacement, or improvement made within the spirit and principle of this disclosure shall fall within the scope of this disclosure.

What is claimed is:

1. A virtual element decoration method, comprising:
outputting for display a first virtual object and an element decoration area in a virtual scene, the element decoration area including a region with an element decoration function, the element decoration function being configured to provide a decoration for the first virtual object;
receiving, by processing circuitry, an object control operation performed on an object control element associated with the first virtual object, the object control element being configured to cause the first virtual object to interact with the element decoration area in the virtual scene; and
outputting for display, based on the object control operation performed on the object control element, the first virtual object decorated with a first virtual element, the first virtual element including a virtual decoration element determined based on the object control operation causing interaction of the first virtual object with the element decoration area.

2. The method according to claim 1, wherein
the element decoration area is a three-dimensional spatial area in the virtual scene, and
the object control operation performed on the object control element causes the first virtual object to move to, and interact with, the three-dimensional spatial area in which the element decoration area is located.

3. The method according to claim 1, wherein
the element decoration area includes a virtual decoration wall, and
the receiving the object control operation comprises:
receiving a first movement operation performed on a movement control element, the first movement operation causing the first virtual object to pass through the virtual decoration wall.

4. The method according to claim 1, wherein
the element decoration area includes a decoration scene area indicating a scene region within a preset range of the virtual scene, and the receiving the object control operation comprises:
receiving a movement operation performed on a movement control element, the movement operation causing the first virtual object to move to the decoration scene area.

5. The method according to claim 1, wherein the element decoration area includes a preview sub-area and a decoration sub-area, the preview sub-area being configured to display a preview of the first virtual element, and the decoration sub-area being configured to decorate the first virtual object with the first virtual element displayed in the preview sub-area during the interaction with the first virtual object.

6. The method according to claim 1, wherein
the element decoration area includes a plurality of decoration areas respectively corresponding to a plurality of virtual elements; and
the outputting for display the first virtual object decorated with the first virtual element comprises:
outputting for display, based on the object control operation performed on the object control element that causes the first virtual object to interact with a first decoration area of the plurality of decoration areas in the element decoration area, the first virtual object being decorated with the first virtual element.

7. The method according to claim 1, further comprising:
outputting for display a decoration time indicator, indicating a relationship between a decoration duration and a preset decoration duration, wherein the preset decoration duration limits a time period during which the first virtual element is decorated on the first virtual object.

8. The method according to claim 7, further comprising:
outputting for display, based on the decoration duration reaching the preset decoration duration, the first virtual object without the first virtual element.

9. The method according to claim 1, further comprising:
receiving an element configuration operation performed on an element configuration control element of the element decoration area, the element configuration operation being configured to set the first virtual element as a virtual element corresponding to the element decoration function.

10. The method according to claim 9, wherein the receiving the element configuration operation comprises:
receiving a trigger operation performed on the element configuration control element;
outputting for display an element display interface including a plurality of accessory elements, at least one of the plurality of accessory elements being combinable to obtain a virtual element corresponding to the element decoration function; and
receiving an element selection operation performed on the element display interface to select at least one of the plurality of accessory elements as the element configuration operation.

11. The method according to claim 1, wherein the outputting for display the first virtual object decorated with the first virtual element comprises:
outputting for display, based on the object control operation performed on the object control element causing the first virtual object to move from a first side to a second side of the element decoration area, the first virtual object decorated with the first virtual element; and
based on the object control operation performed on the object control element causing the first virtual object to move from the second side to the first side of the element decoration area, outputting for display the first virtual object without the first virtual element.

12. The method according to claim 1, further comprising:
outputting for display, based on the object control operation performed on the object control element causing the first virtual object to interact with the element decoration area according to a first interaction type, the first virtual object decorated with a first accessory element included in the first virtual element; or
outputting for display, based on the object control operation performed on the object control element causing the first virtual object to interact with the element decoration area according to a second interaction type different from the first interaction type, the first virtual object decorated with a second accessory element included in the first virtual element different from the first accessory element.

13. The method according to claim 1, wherein the receiving the object control operation performed on the object control element comprises:
receiving a first object control operation performed on the object control element, the first object control operation causing the first virtual object to interact with a first element decoration area in the virtual scene in which the first virtual object is decorated with the first virtual element; or
receiving a second object control operation performed on the object control element, the second object control operation causing the first virtual object to interact with a second element decoration area in the virtual scene in which the first virtual object is decorated with a second virtual element that is different from the first virtual element.

14. The method according to claim 1, wherein the outputting for display the first virtual object decorated with the first virtual element comprises:
outputting for display, based on the object control operation performed on the object control element, execution of an element switching action in which the first virtual object switches a third virtual element previously decorated on the first virtual object to the first virtual element.

15. The method according to claim 1, wherein the outputting for display the first virtual object decorated with the first virtual element comprises:
outputting for display, based on the object control operation performed on the object control element, execution of an element application action in which the first virtual object applies the first virtual element.

16. The method according to claim 1, wherein the element decoration function provides a try-on mode for the first virtual object, and the outputting for display the first virtual object decorated with the first virtual element comprises:
outputting for display, based on the object control operation performed on the object control element, the first virtual object decorated with the first virtual element in the try-on mode in which the first virtual object is temporarily decorated with the first virtual element.

17. An information processing apparatus, comprising:
processing circuitry configured to:
output for display a first virtual object and an element decoration area in a virtual scene, the element decoration area including a region with an element decoration function, the element decoration function being configured to provide a decoration for the first virtual object;
receive an object control operation performed on an object control element associated with the first virtual object, the object control element being configured to cause the first virtual object to interact with the element decoration area in the virtual scene; and
output for display, based on the object control operation performed on the object control element, the first virtual object decorated with a first virtual element, the first virtual element including a virtual decoration element determined based on the object control operation causing interaction of the first virtual object with the element decoration area.

18. The apparatus according to claim 17, wherein
the element decoration area is a three-dimensional spatial area in the virtual scene, and
the object control operation performed on the object control element causes the first virtual object to move to, and interact with, the three-dimensional spatial area in which the element decoration area is located.

19. The apparatus according to claim 17, wherein
the element decoration area includes a virtual decoration wall, and
the processing circuitry is configured to:
receive a first movement operation performed on a movement control element, the first movement operation causing the first virtual object to pass through the virtual decoration wall.

20. A non-transitory computer-readable storage medium storing instructions which, when executed by a processor, cause the processor to perform:
outputting for display a first virtual object and an element decoration area in a virtual scene, the element decoration area including a region with an element decoration function, the element decoration function being configured to provide a decoration for the first virtual object;
receiving an object control operation performed on an object control element associated with the first virtual object, the object control element being configured to cause the first virtual object to interact with the element decoration area in the virtual scene; and
outputting for display, based on the object control operation performed on the object control element, the first virtual object decorated with a first virtual element, the first virtual element including a virtual decoration element determined based on the object control operation causing interaction of the first virtual object with the element decoration area.
